(19) United States
(12) Patent Application Publication
(10) Pub. No.: US 2026/0371135 A1
(43) Pub. Date: Nov. 19, 2026

(54) PHASE COMPENSATION FOR COHERENT JOINT TRANSMISSION

(71) Applicant: QUALCOMM Incorporated, San Diego, CA (US)

(72) Inventors: Kexin XIAO, Shanghai (CN); Yi HUANG, San Diego, CA (US); Yu ZHANG, San Diego, CA (US); Runxin WANG, San Diego, CA (US); Hung Dinh LY, San Diego, CA (US)

(21) Appl. No.: 19/476,866

(22) PCT Filed: Jul. 3, 2023
(86) PCT No.: PCT/CN2023/105477

§ 371 Date: Oct. 20, 2025

(51) Int. Cl. H04W 24/10; H04B 7/06

(52) U.S. Cl. CPC H04W 24/10; H04B 7/0626; H04B 7/0639

(57) ABSTRACT

Methods, systems, and devices for wireless communications are described. A group of transmission-reception points (TRPs) may be configured for joint transmissions to a user equipment (UE). At least one of the TRPs may be a reference TRP, and the UE may receive reference signaling from the reference TRP within multiple slots. The UE identifies one or more phase jumps associated with the reference signaling, where a phase jump includes a difference between a phase of the reference signaling received by the UE during a first slot and a phase of the reference signaling received by the UE during a subsequent slot. The UE transmits, to a network entity, a report including information that is based on the one or more phase jumps, which may support the reception by the UE of one or more joint transmissions from the group of TRPs.

### CROSS REFERENCE

The present Application is a 371 national phase filing of International PCT Application No. PCT/CN2023/105477 by XIAO et al., entitled “PHASE COMPENSATION FOR COHERENT JOINT TRANSMISSION,” filed Jul. 3, 2023, which is assigned to the assignee hereof, and which is expressly incorporated by reference in its entirety herein.

### FIELD OF TECHNOLOGY

The following relates to wireless communications, including phase compensation for coherent joint transmission (CJT).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support phase compensation for coherent joint transmission (CJT) from a group of transmission-reception points (TRPs) to a user equipment (UE). For example, the described techniques provide for identifying phase jumps associated with reference signaling between one slot and another slot. To account for the phase jumps, the UE may provide a report (e.g., a channel state information (CSI) report) that compensates for the phase jumps or indicates the phase jumps to the network entity, so that the network entity may optimally configure the group of TRPs (e.g., by compensating for the phase jumps) for one or more subsequent joint transmission to the UE.

A method for wireless communication by a UE is described. The method may include receiving reference signaling from at least one reference TRP within a set of multiple slots, the at least one reference TRP included in a group of TRPs configured for joint transmissions to the UE, identifying one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots, transmitting, to a network entity, a report including information that is based on the one or more identified phase jumps, and receiving a joint transmission from the group of TRPs based on the information included in the report.

An apparatus (e.g., a UE) for wireless communication is described. The apparatus may include memory (e.g., one or more memories), a transceiver, and at least one processor coupled with the memory. The at least one processor may be configured (e.g., by the one or more processors individually or collectively executing code stored by the memory) to cause the apparatus to receive reference signaling from at least one reference TRP within a set of multiple slots, the at least one reference TRP included in a group of TRPs configured for joint transmissions to the apparatus, identify one or more phase jumps associated with the reference signaling, where a phase jump of the one or more phase jumps includes a difference between a phase of the reference signaling as received by the apparatus during a first slot of the set of multiple slots and a phase of the reference signaling as received by the apparatus during a subsequent slot of the set of multiple slots, transmit, to a network entity, a report including information that is based on the one or more identified phase jumps, and receive a joint transmission from the group of TRPs based on the information included in the report.

Another apparatus (e.g., a UE) for wireless communication is described. The apparatus may include means for receiving reference signaling from at least one reference TRP within a set of multiple slots, the at least one reference TRP included in a group of TRPs configured for joint transmissions to the apparatus, means for identifying one or more phase jumps associated with the reference signaling, where a phase jump of the one or more phase jumps includes a difference between a phase of the reference signaling as received by the apparatus during a first slot of the set of multiple slots and a phase of the reference signaling as received by the apparatus during a subsequent slot of the set of multiple slots, means for transmitting, to a network entity, a report including information that is based on the one or more identified phase jumps, and means for receiving a joint transmission from the group of TRPs based on the information included in the report.

A non-transitory computer-readable medium storing code for wireless communication at an apparatus (e.g., a UE) is described. The code may include instructions executable by a processor to receive reference signaling from at least one reference TRP within a set of multiple slots, the at least one reference TRP included in a group of TRPs configured for joint transmissions to the apparatus, identify one or more phase jumps associated with the reference signaling, where a phase jump of the one or more phase jumps includes a difference between a phase of the reference signaling as received by the apparatus during a first slot of the set of multiple slots and a phase of the reference signaling as received by the apparatus during a subsequent slot of the set of multiple slots, transmit, to a network entity, a report including information that is based on the one or more identified phase jumps, and receive a joint transmission from the group of TRPs based on the information included in the report.

Some examples of the method, apparatuses, and non-transitory computer-readable medium described herein may further include operations, features, means, or instructions for determining one or more channel state information metrics based on the one or more phase jumps, where the report includes a channel state information report, and where the information includes the one or more channel state information metrics that may be based on the one or more phase jumps.

In some examples of the method, apparatuses, and non-transitory computer-readable medium described herein, the one or more channel state information metrics include a pre-coding matrix indicator value that may be based on the one or more phase jumps, a channel quality indicator value that may be based on the one or more phase jumps, a rank indicator value that may be based on the one or more phase jumps, or any combination thereof.

In some examples of the method, apparatuses, and non-transitory computer-readable medium described herein, the report indicates the one or more phase jumps.

In some examples of the method, apparatuses, and non-transitory computer-readable medium described herein, to indicate the one or more phase jumps, the report indicates a respective phase differential value, relative to a reference slot within the set of multiple slots, for each other slot within the set of multiple slots, where the respective phase differential value for a slot corresponds to a difference between a phase of the reference signaling as received by the UE within the slot and a phase of the reference signaling as received by the UE within the reference slot.

Some examples of the method, apparatuses, and non-transitory computer-readable medium described herein may further include operations, features, means, or instructions for determining one or more channel state information metrics independent of the one or more phase jumps and indicating, via the report or a second report, the one or more channel state information metrics separately from the one or more phase jumps.

In some examples of the method, apparatuses, and non-transitory computer-readable medium described herein, operations, features, means, or instructions for receiving the reference signaling from the at least one reference TRP may include operations, features, means, or instructions for receiving the reference signaling from a same set of one or more reference ports of the at least one reference TRP within each slot of the set of multiple slots.

Some examples of the method, apparatuses, and non-transitory computer-readable medium described herein may further include operations, features, means, or instructions for receiving signaling that indicates, to the UE, the at least one reference TRP and the set of one or more reference ports for receiving the reference signaling.

Some examples of the method, apparatuses, and non-transitory computer-readable medium described herein may further include operations, features, means, or instructions for identifying, by the UE, the at least one reference TRP from among the group of TRPs based on receiving the reference signaling from the at least one reference TRP prior to receiving other reference signaling from one or more other TRPs included in the group of TRPs and identifying, by the UE, the one or more reference ports based on the one or more reference ports being associated with one or more port identities (IDs) that may be lower than one or more other port IDs associated with one or more other ports of the at least one reference TRP.

Some examples of the method, apparatuses, and non-transitory computer-readable medium described herein may further include operations, features, means, or instructions for receiving other reference signaling from one or more other TRPs included in the group of TRPs, where the reference signaling received from the at least one reference TRP may be frequency division multiplexed, time division duplexed, code division multiplexed, or any combination thereof relative to the other reference signaling.

In some examples of the method, apparatuses, and non-transitory computer-readable medium described herein, in a first subset of slots among the set of multiple slots, the reference signaling may be received from the at least one reference TRP and the other reference signaling may be also received from at least one of the one or more other TRPs, and in a second subset of slots among the set of multiple slots, the reference signaling may be received from the at least one reference TRP and the other reference signaling may be not received from any of the one or more other TRPs.

In some examples of the method, apparatuses, and non-transitory computer-readable medium described herein, the reference signaling may be received via first resources and the other reference signaling may be received via second resources included in a same reference signal resource set as the first resources.

In some examples of the method, apparatuses, and non-transitory computer-readable medium described herein, the reference signaling may be received within a same frequency range within each slot of the set of multiple slots.

Some examples of the method, apparatuses, and non-transitory computer-readable medium described herein may further include operations, features, means, or instructions for transmitting, to the network entity, a capability report that indicates an inability of the UE to maintain phase coherence when receiving signaling within multiple slots, where receiving the reference signaling from the at least one reference TRP within the set of multiple slots may be based on the capability report indicating the inability of the UE to maintain phase coherence when receiving signaling within multiple slots.

In some examples of the method, apparatuses, and non-transitory computer-readable medium described herein, receiving the reference signaling from the at least one reference TRP within the set of multiple slots may be based on a quantity of slots associated with channel state information reference signaling from the group of TRPs satisfying a threshold.

A method for wireless communication by a network entity is described. The method may include transmitting, via at least one reference TRP, reference signaling to a UE within a set of multiple slots, the at least one reference TRP included in a group of TRPs configured for joint transmissions to the UE, receiving, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots, and transmitting, via the group of TRPs, a joint transmission to the UE based on the information included in report.

A network entity for wireless communication is described. The network entity may include memory (e.g., one or more memories), a transceiver, and at least one processor coupled with the memory. The at least one processor may be configured (e.g., by the one or more processors individually or collectively executing code stored by the memory) to cause the network entity to transmit, via at least one reference TRP, reference signaling to a UE within a set of multiple slots, the at least one reference TRP included in a group of TRPs configured for joint transmissions to the UE, receive, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots, and transmit, via the group of TRPs, a joint transmission to the UE based on the information included in report.

Another network entity for wireless communication is described. The network entity may include means for transmitting, via at least one reference TRP, reference signaling to a UE within a set of multiple slots, the at least one reference TRP included in a group of TRPs configured for joint transmissions to the UE, means for receiving, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots, and means for transmitting, via the group of TRPs, a joint transmission to the UE based on the information included in report.

A non-transitory computer-readable medium storing code for wireless communication is described. The code may include instructions executable by a processor to cause a network entity to transmit, via at least one reference TRP, reference signaling to a UE within a set of multiple slots, the at least one reference TRP included in a group of TRPs configured for joint transmissions to the UE, receive, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots, and transmit, via the group of TRPs, a joint transmission to the UE based on the information included in report.

In some examples of the method, network entities, and non-transitory computer-readable medium described herein, the report is a channel state information report, and the information includes one or more channel state information metrics that are based at least in part on the one or more phase jumps, and operations, features, means, or instructions for transmitting the joint transmission via the group of TRPs may include operations, features, means, or instructions for transmitting the joint transmission using a common phase configuration for each TRP of the group of TRPs.

In some examples of the method, network entities, and non-transitory computer-readable medium described herein, the one or more channel state information metrics include a pre-coding matrix indicator value that may be based on the one or more phase jumps, a channel quality indicator value that may be based on the one or more phase jumps, a rank indicator value that may be based on the one or more phase jumps, or any combination thereof.

In some examples of the method, network entities, and non-transitory computer-readable medium described herein, the report indicates the one or more phase jumps, and operations, features, means, or instructions for transmitting the joint transmission via the group of TRPs may include operations, features, means, or instructions for transmitting the joint transmission using respective phase configurations for the TRPs in the group of TRPs, where the respective phase configurations may be different for at least two TRPs in the group of TRPs and may be based on the one or more indicated phase jumps.

In some examples of the method, network entities, and non-transitory computer-readable medium described herein, to indicate the one or more phase jumps, the report indicates a respective phase differential value for each other slot within the set of multiple slots relative to a reference slot within the set of multiple slots, where the respective phase differential value for a slot corresponds to a difference between a phase of the reference signaling as received by the UE within the slot and a phase of the reference signaling as received by the UE within the reference slot.

Some examples of the method, network entities, and non-transitory computer-readable medium described herein may further include operations, features, means, or instructions for receiving, via the report or a second report from the UE, second information that one or more channel state information metrics separately from the one or more phase jumps, where one or more channel state information metrics may be independent of the one or more phase jumps.

In some examples of the method, network entities, and non-transitory computer-readable medium described herein, operations, features, means, or instructions for transmitting the reference signaling via the at least one reference TRPs may include operations, features, means, or instructions for transmitting the reference signaling via a same set of one or more reference ports of the at least one reference TRP within each slot of the set of multiple slots.

Some examples of the method, network entities, and non-transitory computer-readable medium described herein may further include operations, features, means, or instructions for transmitting signaling that indicates, to the UE, the at least one reference TRP and the set of one or more reference ports.

In some examples of the method, network entities, and non-transitory computer-readable medium described herein, the at least one reference TRP transmits the reference signaling before one or more other TRPs included in the group of TRPs transmit other reference signaling to the UE, and the one or more reference ports may be associated with one or more port IDs that may be lower than one or more other port IDs associated with one or more other ports of the at least one reference TRP.

Some examples of the method, network entities, and non-transitory computer-readable medium described herein may further include operations, features, means, or instructions for transmitting other reference signaling via one or more other TRPs included in the group of TRPs, where the reference signaling transmitted via the at least one reference TRP may be frequency division multiplexed, time division duplexed, code division multiplexed, or any combination thereof relative to the other reference signaling.

In some examples of the method, network entities, and non-transitory computer-readable medium described herein, in a first subset of slots among the set of multiple slots, the reference signaling may be transmitted via the at least one reference TRP and the other reference signaling may be also transmitted via at least one of the one or more other TRPs, and in a second subset of slots among the set of multiple slots, the reference signaling may be transmitted via the at least one reference TRP and the other reference signaling may be not transmitted via any of the one or more other TRPs.

In some examples of the method, network entities, and non-transitory computer-readable medium described herein, the reference signaling may be transmitted via first resources and the other reference signaling may be transmitted via second resources included in a same reference signal resource set as the first resources.

In some examples of the method, network entities, and non-transitory computer-readable medium described herein, the reference signaling may be transmitted within a same frequency range within each slot of the set of multiple slots.

Some examples of the method, network entities, and non-transitory computer-readable medium described herein may further include operations, features, means, or instructions for receiving, from the UE, a capability report that indicates an inability of the UE to maintain phase coherence when receiving signaling within multiple slots, where transmitting the reference signaling via the at least one reference TRP within the set of multiple slots may be based on the capability report indicating the inability of the UE to maintain phase coherence when receiving signaling within multiple slots.

Some examples of the method, network entities, and non-transitory computer-readable medium described herein may further include operations, features, means, or instructions for transmitting reference signaling from the at least one reference TRP within the set of multiple slots based on a quantity of slots associated with channel state information reference signaling from the group of TRPs satisfying a threshold.

### BRIEF DESCRIPTION OF THE DRAWINGS

FIG. 1 shows an example of a wireless communications system that supports phase compensation for coherent joint transmission (CJT) in accordance with one or more aspects of the present disclosure.

FIG. 2 shows an example of a wireless communications system that supports phase compensation for CJT in accordance with one or more aspects of the present disclosure.

FIG. 3 shows an example of a wireless communications system that supports phase compensation for CJT in accordance with one or more aspects of the present disclosure.

FIG. 4 shows an example of a wireless communications system that supports phase compensation for CJT in accordance with one or more aspects of the present disclosure.

FIG. 5 shows an example of a wireless communications system that supports phase compensation for CJT in accordance with one or more aspects of the present disclosure.

FIG. 6 shows an example of a process flow that supports phase compensation for CJT in accordance with one or more aspects of the present disclosure.

FIGS. 7 and 8 show block diagrams of devices that support phase compensation for CJT in accordance with one or more aspects of the present disclosure.

FIG. 9 shows a block diagram of a communications manager that supports phase compensation for CJT in accordance with one or more aspects of the present disclosure.

FIG. 10 shows a diagram of a system including a device that supports phase compensation for CJT in accordance with one or more aspects of the present disclosure.

FIGS. 11 and 12 show block diagrams of devices that support phase compensation for CJT in accordance with one or more aspects of the present disclosure.

FIG. 13 shows a block diagram of a communications manager that supports phase compensation for CJT in accordance with one or more aspects of the present disclosure.

FIG. 14 shows a diagram of a system including a device that supports phase compensation for CJT in accordance with one or more aspects of the present disclosure.

FIGS. 15 and 16 show flowcharts illustrating methods that support phase compensation for CJT in accordance with one or more aspects of the present disclosure.

### DETAILED DESCRIPTION

Some wireless communication systems may involve multiple transmission-reception points (TRPs) for a network entity to communicate with a user equipment (UE), where the multiple TRPs may jointly transmit (e.g., using coherent joint transmission (CJT)) signaling to the UE. In some cases, channel state information reference signaling (CSI-RS) may be received by the UE from different TRPs in different slots, and the UE may use the CSI-RS to estimate the downlink channel and report channel state information to the network entity. Phase jumps (changes in phase from one slot to another) may occur for the CSI-RS signaling from the different TRPs when received over multiple slots. For example, as perceived by the UE, the CSI-RS signaling received in a first slot may have a different phase than the CSI-RS signaling received in a subsequent, second slot. Other signaling (e.g., a PDSCH transmission), however, may be jointly transmitted by the group of TRPs within a single slot, and hence may not be subject to phase jump behavior. This mismatch may negatively impact the reliability with which the single-slot signaling is received by the UE, as the single-slot signaling may be transmitted in a manner (e.g., using a precoder, modulation and coding scheme (MCS), etc.) that is suboptimal. For example, the single-slot signaling transmission may be suboptimal due to being based on CSI from the UE that is based on the multi-slot CSI-RS signaling subject to phase jump behavior.

With a group of TRPs configured for joint transmission (e.g., CJT) to the UE, one or more TRPs may act as a reference TRP and transmit reference signaling across multiple slots. The UE may identify phase jumps associated with the reference signaling from the one or more reference TRPs, and this phase jump information may be used to more optimally configure the group of TRPs for one or more subsequent joint transmissions to the UE. For example, the UE may report CSI that compensates for the phase jump behavior, with the or more subsequent joint transmissions configured based on such compensated CSI. In some examples, the UE may directly report the phase jump information to the network so that the network may account for it when configuring the group of TRPs for the one or more subsequent joint transmissions.

In some examples, within each slot in which the phase jump reference signaling is transmitted, the one or more reference TRPs may transmit the phase jump reference signaling via the same one or more ports, which may be referred to as reference ports. The other TRPs in the group of TRPs may transmit CSI-RS in at least some of the same slots. In some examples, the phase jump reference signaling may be frequency division multiplexed (FDM), time division multiplexed (TDM), and/or code division multiplexed (CDM) with the CSI-RS. In some examples, where the UE reports CSI that compensates for (e.g., includes one or more CSI metrics with values based on) the phase jumps, the network may configure each TRP to transmit the one or more subsequent joint transmissions using a common transmit phase. In some examples, where the UE reports CSI that does not compensate for the phase jumps, the UE may indicate the phase jumps to the network, and the network may individually adjust the transmit phase for each of TRP of the group when transmitting the one or more subsequent joint transmissions. In some examples, the UE may transmit a capability report indicating an inability of the UE to maintain phase coherence when receiving CSI-RSs across the multiple slots, and the UE may receive the phase jump reference signaling based on the capability report. In some examples, the UE may receive the phase jump reference signaling based on a quantity of slots associated with receiving CSI-RS from the group of TRPs satisfying a threshold (e.g., being greater than one).

Aspects of the disclosure are initially described in the context of wireless communications systems. Aspects of the disclosure are further illustrated by and described with reference to apparatus diagrams, system diagrams, and flowcharts that relate to phase compensation for CJT.

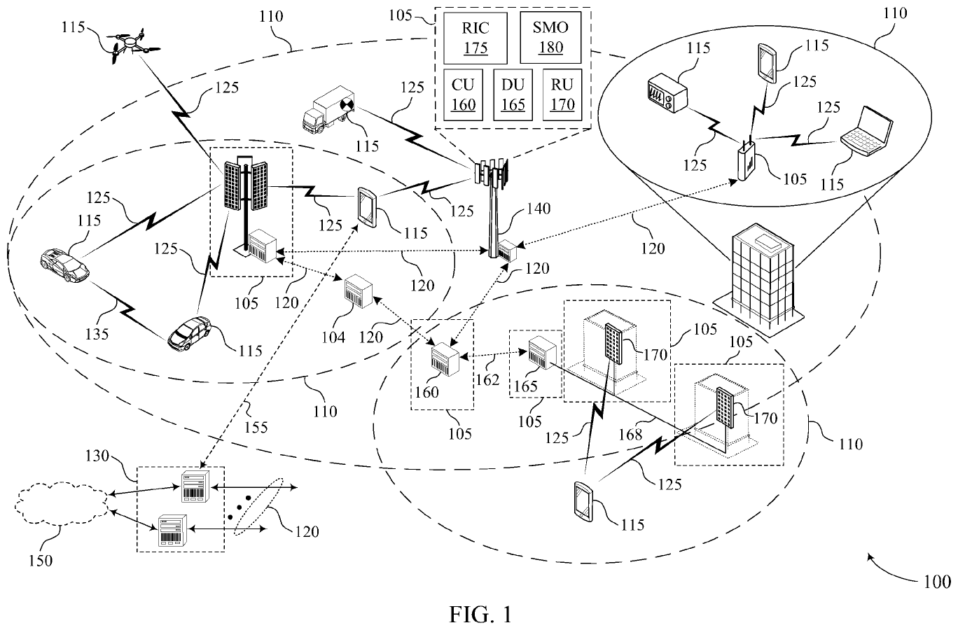

FIG. 1 shows an example of a wireless communications system 100 that supports phase compensation for CJT in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support phase compensation for CJT as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the network entity 105 may communicate with the UE 115 via a downlink channel, such as a physical downlink control channel (PDCCH), and the downlink channel may be adapted based on conditions at the UE 115. For example, the UE 115 may receive a CSI-RS from the network entity 105 via one or more TRPs, the UE 115 may estimate the channel conditions, and the UE 115 may provide a CSI report to the network entity 105 so that the network entity 105 may adapt the downlink control channel accordingly. In some examples, the UE may estimate an Mᵣ×Mₜ downlink channel matrix H based on Mt-port CSI-RS, where Mt refers to the quantity of antenna ports used by the network entity 105 to transmit the CSI-RSs, and Mᵣ refers to the quantity of antenna ports used by the UE 115 to receive the CSI-RSs. The network entity 105 may indicate to the UE 115, for example in RRC signaling, a codebook type and one or more codebook parameters to use in generation of the CSI report. For example, an RRC information element CSI-ReportConfig may indicate the antenna ports indices, P, which are used for each layer from rank 1 to rank R (e.g., {{P₁(0), . . . , P₁(L₁−1)}, . . . , {P_{R}(0), . . . , P_{R}(L_{R}−1)}}. The UE 115 may determine the rank r* and the precoding matrix index for a given codebook, as (r*, i*)=argmax_{r,i}SEₑₛₜ(H, Pᵣ(i)). SEₑₛₜ(H, Pᵣ(i)) refers to the spectral efficiency estimation when H and Pᵣ(i) are given, r* refers to an optimal rank, and P_{r*}(i*) refers to an optimal precoder. The UE 115 may calculate the channel quality index (CQI) as CQI*=ƒ(SEₑₛₜ(H,P_{r*}(i*))). The CSI report may include a rank indicator (RI), a PMI, and/or a CQI calculated using the indicated codebook type for the indicated quantity of CSI antenna ports, Mₜ.

In some examples, the CSI-RS from different TRPs may transmitted and received in different slots. When the UE 115 receives CSI-RS in multiple slots, such as for downlink channel estimation at the UE 115 (e.g., receiver side), phase jumps associated with the CSI-RS from the one or more TRPs may occur, as discussed herein. The jumped phase may be considered part of the channel information when UE 115 determines CSI, which may include PMI, CQI, RI, or any combination thereof. However, when UE 115 receives CJT physical downlink shared channel (PDSCH) within a single slot, there may be no phase jump at the receiver side since the signaling is received at the one single slot instead of multiple slots that may be susceptible to phase jumping. A phase mismatch may occur between the downlink channel for transmitting the CSI-RS and the downlink channel for transmitting PDSCH, to the UE 115.

Accordingly, the network entity 105 may maintain a same phase offset at the antenna ports for the multiple TRPs for PDSCH transmission and for the CSI-RS transmission. With respect to the transceiver side, each TRP may maintain phase coherence (or store a phase status) during the time period of transmitting CSI-RS and PDSCH. In some examples, and with respect to the receiver side, the UE 115 may be unable to maintain a phase coherence during reception of each of the CSI-RS. As discussed herein, the received phase jumps in CJT may be estimated and compensated for to resolve the phase mismatch that may otherwise occur when the UE 115 receives the CSI-RS in multiple slots.

In particular, with a group of TRPs configured for CJT to the UE 115, one or more TRPs may act as a reference TRP and transmit reference signaling (e.g., the CSI-RS) across multiple slots. The UE 115 may identify phase jumps associated with the reference signaling from the one or more reference TRPs, and this phase jump information can be used to more optimally configure the group of TRPs for one or more subsequent joint transmissions to the UE 115. For example, the UE 115 can then report CSI that compensates for the phase jump behavior, with the or more subsequent joint transmissions configured based on such compensated CSI, or the UE 115 can directly report the phase jump information to the network so that the network can account for it when configuring the group of TRPs for the one or more subsequent joint transmissions.

In some examples, within each slot in which the phase jump reference signaling is transmitted, the one or more reference TRPs may transmit the phase jump reference signaling via the same one or more ports (e.g., antenna ports), which may be referred to as reference ports. The other TRPs in the group of TRPs may transmit CSI-RS in at least some of the same slots. In some examples, the phase jump reference signaling may be FDM, TDM, and/or CDM with the CSI-RS. In some examples, where the UE 115 reports CSI that compensates for (e.g., includes one or more CSI metrics with values based on) the phase jumps, the network may configure each TRP to transmit the one or more subsequent joint transmissions using a common transmit phase. In some examples, where the UE 115 reports CSI that does not compensate for the phase jumps, the UE 115 may indicate the phase jumps to the network, and the network may individually adjust the transmit phase for each of TRP of the group when transmitting the one or more subsequent joint transmissions. In some examples, the UE 115 may transmit a capability report indicating an inability of the UE 115 to maintain phase coherence when receiving CSI-RSs across the multiple slots, and the UE 115 may receive the phase jump reference signaling based on the capability report. In some examples, the UE 115 may receive the phase jump reference signaling based on a quantity of slots associated with receiving CSI-RS from the group of TRPs satisfying a threshold (e.g., being greater than one).

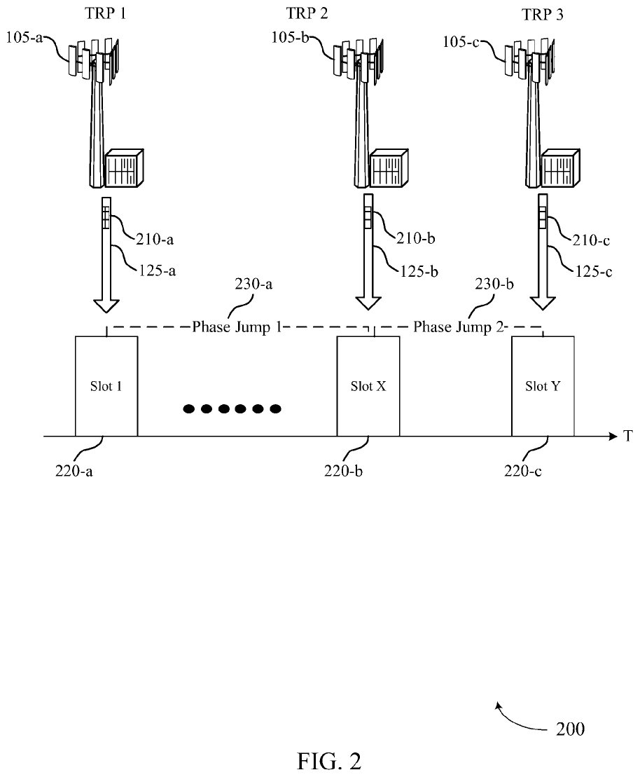

FIG. 2 shows an example of a wireless communications system 200 that supports phase compensation for CJT in accordance with one or more aspects of the present disclosure. The wireless communications system 200 may implement or may be implemented by aspects of the wireless communications system 100. For example, the wireless communications system 200 may include TRPs 105-a, 105-b, and 105-c, which may each be associated with a network entity (e.g., network entity configures each of the TRPs) or may be an example of a network entity as described herein. The wireless communications system 200 may include communication links 125-a, 125-b, and 125-c, which may each be examples of a communication link 125 as described with respect to wireless communications system 100.

In some examples, the TRPs 105 may communicate with a UE 115 in one or more slots 220 using communication links 125. A communication link 125-a may be an example of an NR or LTE link between the UE 115 and the TRP 105-a. The communication link 125-a may include a downlink communication link. For example, the TRP 105-a may transmit downlink signals (e.g., downlink transmissions), such as downlink control signals or downlink data signals, to the UE 115 using the communication link 125-a. In some examples, the TRPs 105 may transmit reference signaling 210 (e.g., CSI-RS) over the communication links 125 that is received by the UE 115 in the one or more slots 220. Although the reference signaling 210 discussed herein is received at three slots 220, including a slot 220-a (slot 1), a slot 220-b (slot x), and a slot 220-c (slot y), the UE 115 may receive the reference signaling 210 over multiple slots (as indicated by the ellipses), up to Y slots (e.g., greater than two slots). The TRP 105-a, TRP 105-b, and TRP 105-c may each be reference TRPs. Although the reference TRPs 105 discussed herein include multiple TRPs 105, the reference TRP 105 may be a single TRP 105 that transmits multiple reference signaling 210.

The UE 115 may receive reference signaling 210-a from the TRP 105-a at the slot 220-a (slot 1) via communication link 125-a. The UE 115 may also receive reference signaling 210-b from the TRP 105-b at the slot 220-b (slot X) via communication link 125-b. The UE 115 may also receive the reference signaling 210-c from the TRP 105-c at the slot 220-c (slot Y) via communication link 125-c. Accordingly, the reference signaling 210 may be received via the reference TRPs 105-a, 105-b, and 105-c in multiple slots 220.

However, reference signaling 210 received by the UE 115 in multiple slots 220 may result in phase jumping. For example, the reference signaling 210-a received at slot 220-a may be associated with a first phase while the reference signaling 210-b received by the UE 115 at slot 220-b is associated with a second phase, where the phases are not the same. That is, a phase jump 230-a (phase jump 1) or difference in phases occurs between the first phase of the reference signaling 210-a received in slot 220-a and the second phase of the reference signaling 210-b received in slot 220-b. Similarly, the reference signaling 210-b received at slot 220-b may be associated with the second phase while the reference signaling 210-c received by the UE 115 at slot 220-c is associated with a third phase, where the phases are not the same. A phase jump 230-b (phase jump 2) or difference in phases occurs between the second phase of the reference signaling 210-b received in slot 220-b and the third phase of the reference signaling 210-c received in slot 220-c.

In some examples, a uniform linear array (e.g., uniform linear array with N transmission antenna ports for each TRP 105) may be applied for each of m TRPs, m=1. M, where m refers to a quantity of TRPs and M refers to a quantity greater than 1. Transmission initial phases of the reference signaling 210 may be calibrated, and the reference signaling 210 may be transmitted from n antenna ports, n=1 . . . . N, where n refers to a quantity of antenna ports and N refers to a quantity greater than 1. The UE 115 may receive the reference signaling 210 (e.g., CSI-RS) from the TRPs 105 at a slot x 220, which may be defined by the following equation:

$${y}_{mn}^{x} ( k ) = {e}^{j {α}_{x}} {e}^{j {φ}_{m}} {h}_{m} ( k ) {e}^{j \frac{2 π}{λ} ndsin θ} + ϖ ( k ) , m = 1 … M , n - 1 … N ,$$

where φₘ refers to a common phase for all transmission antenna ports of the m TRPs. For example, the phase for each n transmission referencing signaling 210 may be calibrated to a common phase φₘ. The αₓ may refer to the phase at slot x 220. In some examples, the UE 115 may receive a first reference signaling 210-a (e.g., CSI-RS 1) with α₁ and receive the second reference signaling 210-b (e.g., CSI-RS 2) with αₓ. The hₘ(k) refers to the channel on tone k, d refers to the distance between transmission antenna ports of the TRP 105, θ refers to the angle of transmission of the reference signaling 210, and ω̅(k) refers to the noise on tone k. By way of example, if TRP 105-a is the reference TRP, the relative phase between TRP 1 and TRP m may be defined as (αₓ+φₘ)−(α₁+φ₁), and αₓ−α₁ may be the phase offset to be compensated.

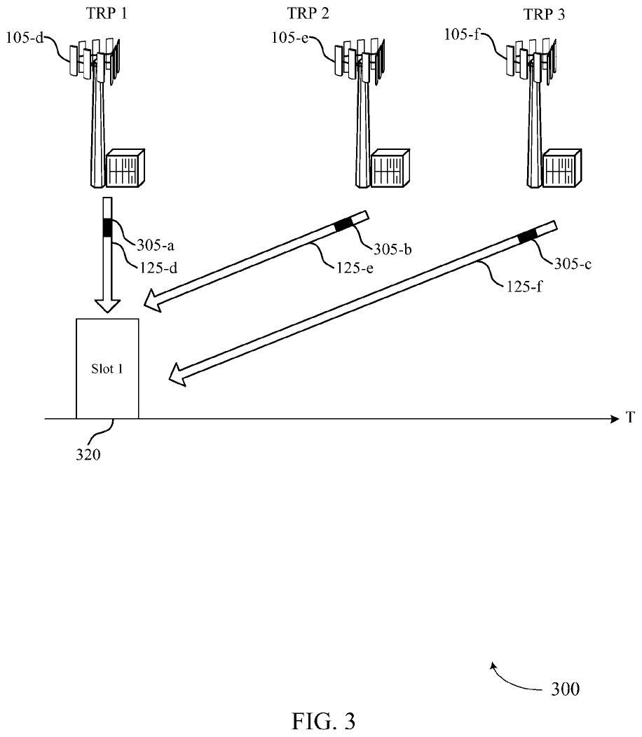

As will be discussed with respect to FIG. 3, signaling for a PDSCH may be transmitted from the reference TRPs 105 over a downlink channel (e.g., the communication links 125) in a single slot 220. Since each of the PDSCH signaling is received by the UE 115 in the same slot 220, the different PDSCH signaling from the TRPs 105 may not be associated with different phases that result in phase jumps. A phase mismatch may occur for the reference signaling 210 and the PDSCH signaling since the reference signaling is associated with the phase jumps while the PDSCH signaling is not associated with any phase jumps.

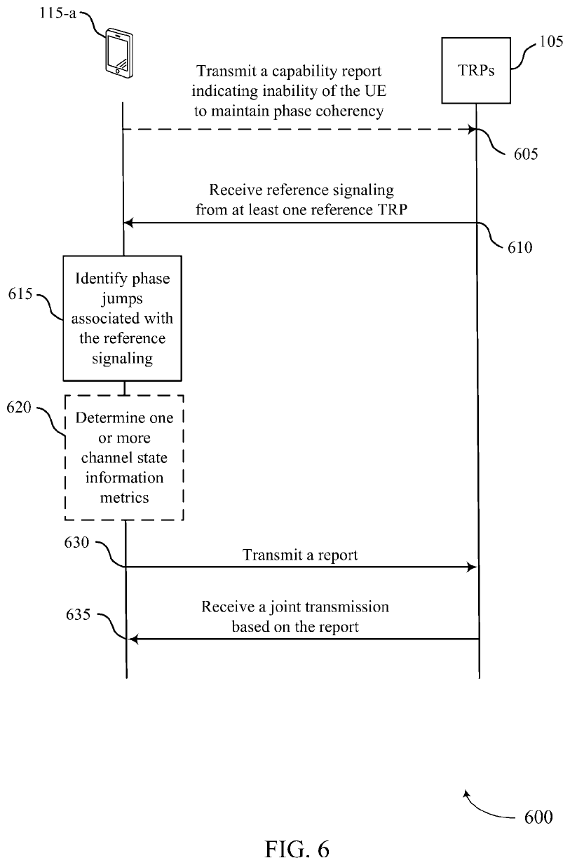

In some examples, as will be discussed with respect to FIG. 6, the UE 115 may receive the reference signaling 210 to determine a CSI or CQI of the downlink channel (e.g., communication link 125-a). In such examples, the communication link 125-a may be a bidirectional communication link so that UE 115 may report the quality of the downlink channel to the network entity using uplink signals.

FIG. 3 shows an example of a wireless communications system 300 that supports phase compensation for CJT in accordance with one or more aspects of the present disclosure. The wireless communications system 300 may implement or may be implemented by aspects of the wireless communications system 100 and 200. For example, the wireless communications system 300 may include TRPs 105-d, 105-e, and 105-f, which may each be associated with a network entity (e.g., network entity configures each of the TRPs) or may be an example of a network entity as described herein. The wireless communications system 300 may include communication links 125-d, 125-e, and 125-f, which may each be examples of a communication link 125 as described with respect to wireless communications systems 100 and 200.

In some examples, the UE 115 may receive PDSCH signaling 305 from each of the reference TRPs 105 in a single slot, such as slot 320 (slot 1), over the communication links 125. For example, the UE 115 may receive a PDSCH signaling 305-a over communication link 125-d, a PDSCH signaling 305-b over communication link 125-e, and a PDSCH signaling 305-c over communication link 125-f, each in slot 320. Since each of the PDSCH signaling 305 is received by the UE 115 in the same slot 320, the PDSCH signaling 305 from the different TRPs 105 may not be associated with different phases that result in a phase jump. Accordingly, a phase mismatch may occur between reference signaling and the PDSCH signaling 305 since the reference signaling is associated with the phase jumps while the PDSCH signaling 305 is not associated with any phase jumps.

For CJT PDSCH signaling 305 transmission, the PDSCH signaling 305 may be transmitted from n antenna ports of the TRPs, n=1 . . . . N, where n refers to a quantity of antenna ports and N refers to a quantity greater than 1. The PDSCH signaling 305 may be received by the UE 115 (e.g., receiver) at slot z (here, slot 320 (slot 1)), which may be defined by the following equation:

$${y}_{mn}^{x} ( k ) = {e}^{j {α}_{PDSCH}} {e}^{j {\hat{φ}}_{m}} {h}_{m} ( k ) {e}^{j \frac{2 π}{λ} ndsin θ} + ϖ ( k ) , m = 1 … M , n - 1 … N ,$$

where φ̅ₘ refers to the common phase for all transmission antenna ports in m TRPs 105, α_{PDSCH} refers to the phase at slot z for receiving the PDSCH signaling 305. The hₘ(k) refers to the channel on tone k, d refers to the distance between antenna ports, θ refers to the angle of transmitting the PDSCH signaling 305, and ω̅(k) refers to the noise on tone k. To compensate for or maintain the same phase offset at the antenna ports of the reference TRPs 105 when transmitting the PDSCH signaling 305 and the prior reference signaling 210, the UE 115, the network entity, or both, may compensate for αₓ.

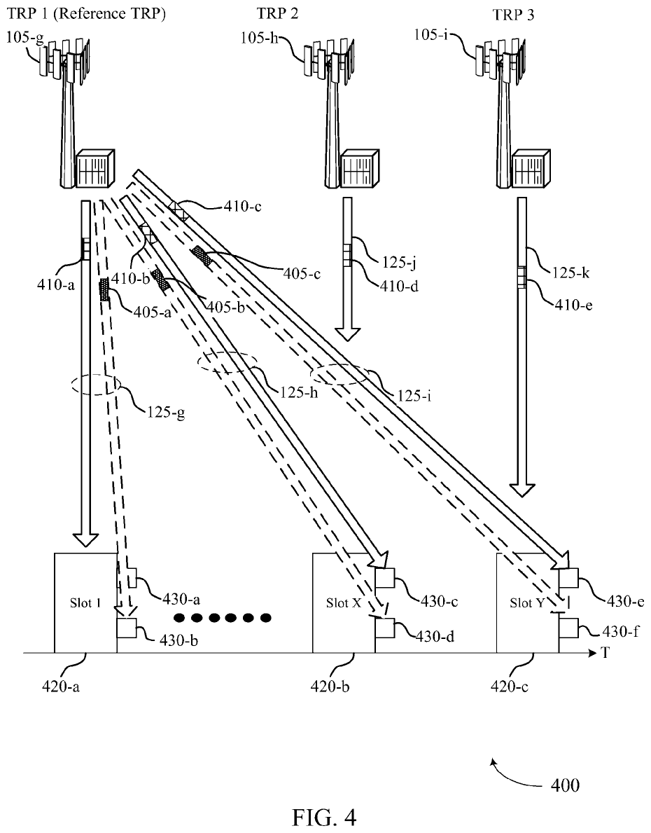

FIG. 4 shows an example of a wireless communications system 400 that supports phase compensation for CJT in accordance with one or more aspects of the present disclosure. The wireless communications system 400 may implement or may be implemented by aspects of the wireless communications system 100, 200, and 300. For example, the wireless communications system 400 may include TRPs 105-g, 105-h, and 105-i, which may each be associated with a network entity (e.g., network entity configures each of the TRPs) or may be an example of a network entity as described herein. The wireless communications system 400 may include communication links 125-g, 125-h, 125-i, 125-j, and 125-k, which may each be examples of a communication link 125 as described with respect to wireless communications systems 100, 200, and 300.

The TRP 105-g may be the reference TRP that transmits the signaling to the UE 115 in slots 420 at one or more reference antenna ports 430. For example, the reference TRP 105-g may transmit other reference signaling 405 (e.g., additional reference signaling that is additional to the reference signaling 410). The UE 115 may use the signaling from the reference TRP 105-g to estimate the phase jumps. The UE 115 may receive reference signaling 410-a and other reference signaling 405-a over 125-g in the slot 420-a (slot 1). The UE 115 may receive the other reference signaling 405-a at antenna port 430-b (but not antenna port 430-a). The UE 115 may receive reference signaling 410-b and other reference signaling 405-b over 125-h in slot 420-b (slot X). The UE 115 may receive the reference signaling at 410-b at antenna port 430-c and the other reference signaling 405-b at antenna port 430-d. Additionally, the UE 115 may receive reference signaling 410-c and other reference signaling 405-c over 125-i in slot 420-c (slot Y). The UE 115 may receive the reference signaling at 410-c at antenna port 430-e and the other reference signaling 405-c at antenna port 430-f. The UE 115 may also receive reference signaling 410-d over communication link 125-j from TRP 105-h and reference signaling 410-e over communication link 125-k from TRP 105-i. Since the TRP 105-g is the reference TRP, the UE 115 may use the other reference signaling 405 from the TRP 105-g to identify phase jumps associated with the reference signaling 410. In particular, the same antenna ports of the reference TRP 105-g transmit the reference signaling 410 and the other reference signaling 405. Receiving reference signaling 410 and the other reference signaling 405 from the same antenna ports of the same reference TRP 105-g may enable the UE 115 to accurately identify or estimate the phase jumps.

The other reference signaling 405 may be used to track or match the phases of the reference signaling 410 at the UE 115 (e.g., at the receiver). For example, the other reference signaling 405 may be repeatedly transmitted in the slot where M reference signaling 410 (e.g., CSI-RS) is transmitted. In some examples, the other reference signaling 405 may be repeatedly transmitted from the same reference antenna port(s) of the same reference TRP(s) 105, such as TRP 105-g. By transmitting the reference signaling 410 and the other reference signaling 405 from the same antenna port of the same reference TRP 105-g and/or in the same slot 420, the UE 115 may be enabled to accurately identify or estimate the phase jumps. For example, the UE 115 may use single or multiple TRPs 105, single or multiple antenna ports(s) 430, or any combination thereof, to estimate the phases of the reference signaling 410. In some examples, if the reference TRP 105-g and the reference port(s) 430 have not been configured for transmitting or receiving the reference signaling 410, the TRP 105 transmitting the earliest reference signaling 410 and the ports with lowest port identification (ID) may be the reference TRP 105 and the reference antenna port 430. In some examples, the reference TRP(s) 105 and the reference port(s) 430 may be configured by the network (e.g., network entity). Since the reference signaling 410 and corresponding other reference signaling 405 are received by the UE 115 at the same slots 420, the UE 115 may estimate the phase of the reference signaling 410 using the other reference signaling 405. The UE 115 may estimate the phases to compensate for or adjust for the phases. In particular, the UE 115 may compensate for by adjusting parameters of a report that the UE 115 may transmit to the network entity 105, as discussed with respect to FIG. 6.

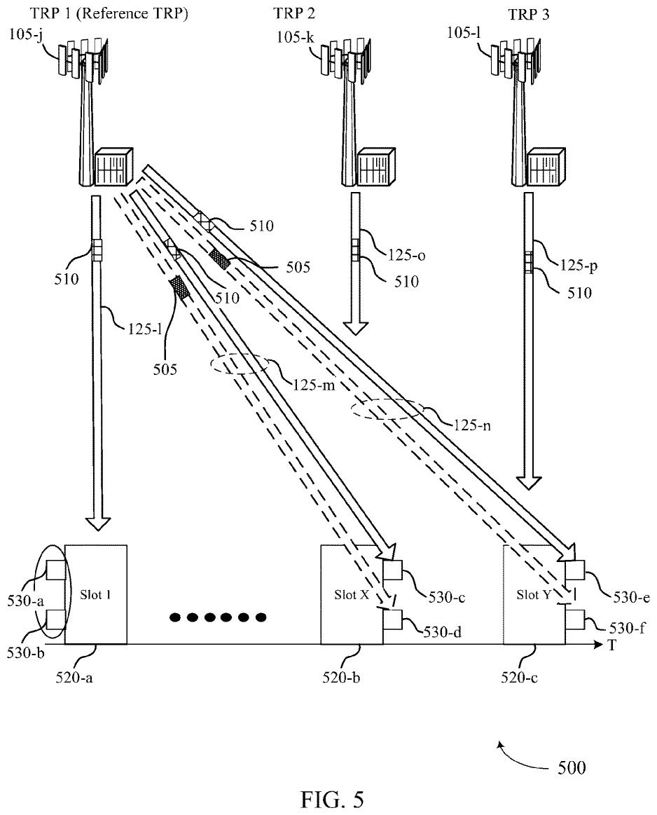

FIG. 5 shows an example of a wireless communications system 500 that supports phase compensation for CJT in accordance with one or more aspects of the present disclosure. The wireless communications system 500 may implement or may be implemented by aspects of the wireless communications system 100, 200, 300, and 400. For example, the wireless communications system 500 may include TRPs 105-j, 105-k, and 105-l, which may each be associated with a network entity 105 (e.g., network entity configures each of the TRPs) or may be an example of a network entity 105 as described herein. The wireless communications system 500 may include communication links 125-l, 125-m, 125-n, 125-0, and 125-p, which may each be examples of a communication link 125 as described with respect to wireless communications systems 100, 200, 300, and 400.

The UE 115 may receive respective reference signaling 510 from the TRPs 105 (e.g., 105-j, 105-k, and 105-1) via respective communication links (e.g., 125-l, 125-m, 125-n, 125-o, and 125-p) in respective slots 520 (e.g., slot 520-a, 520-b, and 520-c). However, the TRP 105-j may be the reference TRP 105 that transmits signaling to the UE 115 in slots 520 to one or more reference antenna ports 530 for the UE 115. The reference TRP 105-j may transmit other reference signaling 505 (e.g., additional reference signaling that is additional to the reference signaling 510). For example, the UE 115 may use the signaling from the reference TRP 105-j to estimate the phase jumps.

The UE 115 may receive reference signaling 510 from the reference TRP 105-j at slot 520-a, port 530-c of slot 520-b, and port 530-e of slot 520-c. However, the UE 115 may receive the other reference signaling 505 from the reference TRP 105-j at port 530-d of slot 520-b and port 530-f of slot 520-c. That is, the UE 115 may receive the reference signaling 510 at each of the slots 520 but receive the other reference signaling 505 that is used for tracking the reference signaling 510, in slot 520-b and 520-c (e.g., not slot 520-a). For example, the UE 115 may receive the reference signaling 510 at the slot 520, such as port 530-a, 530-b, or both, but the UE 115 may not receive any of the other reference signaling 505 at either of these ports 530.

The ports 530 used for receiving the other reference signaling 505 may be based on the techniques discussed with respect to FIG. 5 (e.g., configured or based on lowest port ID). In some examples, the resource (e.g., slot 520) for receiving the other reference signaling 505 may be set separately than for the reference signaling 510, for example, in orthogonal resources FDM, TDM, and/or CDM, with respect to the existing resources for the reference signaling 510. In some examples, the type of the other reference signaling 505 may be the same type of signal as the reference signaling 510 (e.g., CSI-RS) or a different type. If the type of the other reference signaling 505 is same as the reference signaling 510, the other reference signaling 505 for tracking the phase may not be transmitted in the same slot 520 as the reference signaling 510. In some examples, resources (e.g., slot 520) of the other reference signaling 505 may be configured in the same resource set as the referencing signal 505. In some examples, resources of the other reference signaling 505 may be configured in different slots 520 than the reference signaling 505 but the frequency division resources may be the same.

FIG. 6 shows an example of a process flow 600 that supports phase compensation for CJT in accordance with one or more aspects of the present disclosure. The process flow 600 may implement or be implemented by aspects of wireless communications system 100-500. For example, the process flow 600 may include a UE 115-a, which may be an example of a UE 115 as described herein. The process flow 600 may also include some quantity of TRPs 105, where the TRPs are configured by, associated with, or is a network entity. The TRPs 105 in FIG. 6 is a group of TRPs 105 that includes one or more reference TRPs 105 and one or more other TRPs 105. In the following description of the process flow 600, the operations between the TRPs 105 and the UE 115-a may be transmitted in a different order than the example order shown, or the operations performed by the TRPs 105 and the UE 115-a may be performed in different orders or at different times. Some operations may also be omitted from the process flow 600, and other operations may be added to the process flow 600.

In some examples, at 605, the UE 115-a may transmit, to a network entity (e.g., a via a TRP 105), a capability report that indicates an inability of the UE 115-a to maintain phase coherence when receiving reference signaling during multiple slots. As such, receiving reference signaling from at least one reference TRP 105 within the multiple slots may be based on the capability report indicating the inability of the UE 115-a to maintain phase coherence when receiving reference signaling during multiple slots. For example, if all of the reference signaling from different TRPs 105 are configured to transmit within one slot, then phase compensation may not be performed since phase jumps occur when the reference signaling is received in multiple slots. However, if the reference signaling from the different TRPs 105 are transmitted in multiple slots, the phase compensation may be provided based on capability reports. In some examples, the network entity may enable the other reference signaling for phase estimation based on the capability report. The UE 115-a may report whether the UE115-a is capable of maintaining phase coherence in subsequent slots to receive multiple reference signaling. In some examples, the network entity may decide whether to enable the other reference signaling for phase estimation. For example, if the duration for transmitting all of the reference signaling is greater than Y slots, then the network entity 105 may enable the reference signaling for the UE 115-a to estimate the phase. Otherwise, the network entity 105 may disable the phase tracking.

At 610, the UE 115-a may receive reference signaling, from at least one reference TRP 105 within multiple slots. The at least one reference TRP 105 may be included in the group of TRPs 105, which may be configured for joint transmissions to the UE 115-a. In particular, the receiving reference signaling indicates, to the UE 115, the at least one reference TRP 105 and the set of one or more reference ports for receiving the reference signaling. In some examples, the UE 115-a may receive the reference signaling from a same set of one or more reference ports of the at least one reference TRP 105 within each slot of the multiple slots. In some examples, the UE 115-a may identify the at least one reference TRP 105 from among the group of TRPs 105 based on receiving the reference signaling from the at least one reference TRP 105 prior to receiving other reference signaling from one or more other TRPs 105 included in the group of TRPs 105. The UE 115-a may also identify the one or more reference ports of the one or more reference TRPs 105 based at least in part on the one or more reference ports being associated with one or more port IDs that are lower than one or more other port IDs associated with one or more other ports of the at least one reference TRP 105.

In some examples, the UE 115-a receives other reference signaling from one or more other TRPs 105 included in the group of TRPs. And in some cases, the UE 115-a may also receive other reference signaling from the at least one reference TRP 105—for example, all the TRPs 105 may transmit the other reference signaling, and the reference TRP 105 may additionally transmit the reference signaling for phase tracking. The reference signaling received from the at least one reference TRP 105 may be CDM, TDM, CDM, or any combination thereof relative to the other reference signaling. In some examples, the UE 115 may receive, in a first subset of slots among the multiple slots, the reference signaling from the at least one reference TRP 105 and the other reference signaling from at least one of the one or more other TRPs 105. In some examples, the UE 115 may receive, in a second subset of slots among the multiple slots, the reference signaling from the at least one reference TRP 105 and the UE 115 may not receive the other reference signaling from any of the one or more other TRPs 105. In some examples, receiving the reference signaling from the at least one reference TRP 105 within the multiple slots is based on a quantity of slots associated with CSI-RS from the group of TRPs 105 satisfying a threshold.

At 615, the UE 115-a may identify phase jumps associated with the reference signaling. A phase jump of the one or more phase jumps may include a difference between a phase of the reference signaling as received by the UE 115-a during a first slot of the multiple slots and a phase of the reference signaling as received by the UE 115-a during a subsequent slot of the multiple slots. The UE 115-a may estimate the relative received phase differences based on the as-received phases of α₁ . . . am, as discussed with respect to FIG. 2. The UE 115-a may implement channel estimation based on the reference signaling (e.g., CSI-RS), compensate for α₁ . . . αₘ, then calculate the CSI (PMI,CQI,RI). In such examples, the network entity may maintain a phase (e.g., common phase) for each TRP 105 as the TRPs 105 transmits the reference signaling, such that \hat{φ}ₘ=φₘ. In some examples, the UE 115 may implement channel estimation based on referencing signaling and then calculate CSI (PMI,CQI,RI) without compensating for the received phase. In such examples, the UE 115-a may report the CSI and the estimated relative phases to the network. The UE 115-a may use one slot phase as a reference phase (e.g., common phase), calculate the phase difference αₘ−α₀ between αₘ and α₀ for m=1, 2, 3 . . . to M−1, and then quantize am-do (for each m, where m=1 . . . . M−1) into L bits. The UE 115-a may provide a total (M−1)*L bits to network entity and the network entity may adjust the phase for each TRP 105 when transmitting PDSCH accordingly (e.g., \hat{φ}ₘ=φₘ+αₘ).

In some examples, at 620, the UE 115-a determine one or more CSI metrics based on the one or more phase jumps, and a report transmitted by the UE 115-a to the network entity 105 may include a CSI report. The information in the report may include one or more CSI metrics that are based on the one or more phase jumps. In some examples, the one or more CSI metrics include a PMI value that is based on the one or more phase jumps, a CQI value that is based on the one or more phase jumps, a RI value that is based on the one or more phase jumps, or any combination thereof. In some examples, the UE 115-a may determine one or more CSI metrics independent of the one or more phase jumps and indicate, via the report or a second report, the one or more CSI metrics separately from the one or more phase jump.

At 630, the UE 115-a may transmit, to a network entity (e.g., via one or more TRPs of the group of TRPs 105), a report that is based on the one or more identified phase jumps. The report may indicate the one or more phase jumps. To indicate the one or more phase jumps, the report indicates a respective phase differential value, relative to a reference slot within the multiple slots, for each other slot within the multiple slots. The respective phase differential value for a slot may correspond to a difference between a phase of the reference signaling as received by the UE 115-a within the slot and a phase of the reference signaling as received by the UE 115-a within the reference slot.

At 635, the UE 115-a may receive a joint transmission from the group of TRPs based at least in part on the information included in the report. That is, the network entity may use the report from the UE 115-a that already compensates for the phase mismatch or the network entity may adjust the TRPs 105 based on phase jumps indicated in the report in order to compensate for the phase mismatch.

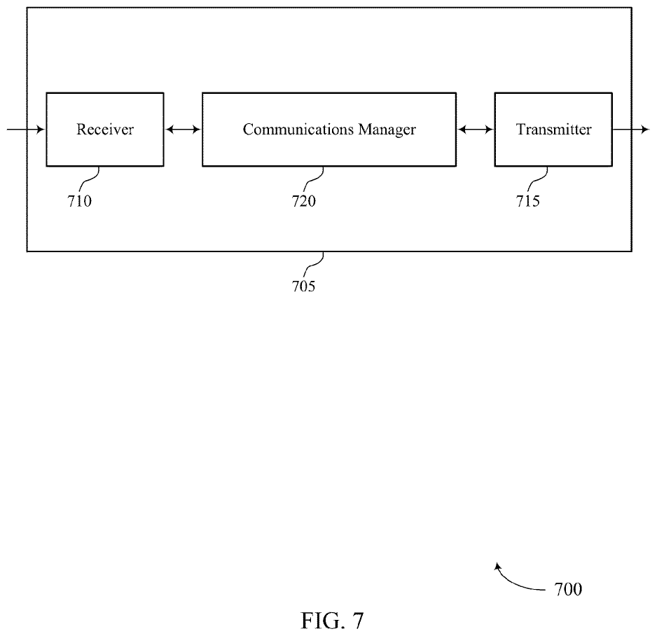

FIG. 7 shows a block diagram 700 of a device 705 that supports phase compensation for CJT in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to phase compensation for CJT). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to phase compensation for CJT). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of phase compensation for CJT as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication by a UE in accordance with examples as disclosed herein. For example, the communications manager 720 is capable of, configured to, or operable to support a means for receiving reference signaling from at least one reference TRP within a set of multiple slots, the at least one reference TRP included in a group of TRPs configured for joint transmissions to the UE. The communications manager 720 is capable of, configured to, or operable to support a means for identifying one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The communications manager 720 is capable of, configured to, or operable to support a means for transmitting, to a network entity, a report including information that is based on the one or more identified phase jumps. The communications manager 720 is capable of, configured to, or operable to support a means for receiving a joint transmission from the group of TRPs based on the information included in the report.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for identifying phase jumps associated with reference signaling from one or more reference TRPs 105 of a group of TRPs 105 so that the phase jump information may be used to optimally configure the group of TRPs for subsequent joint transmission to the UE 115.

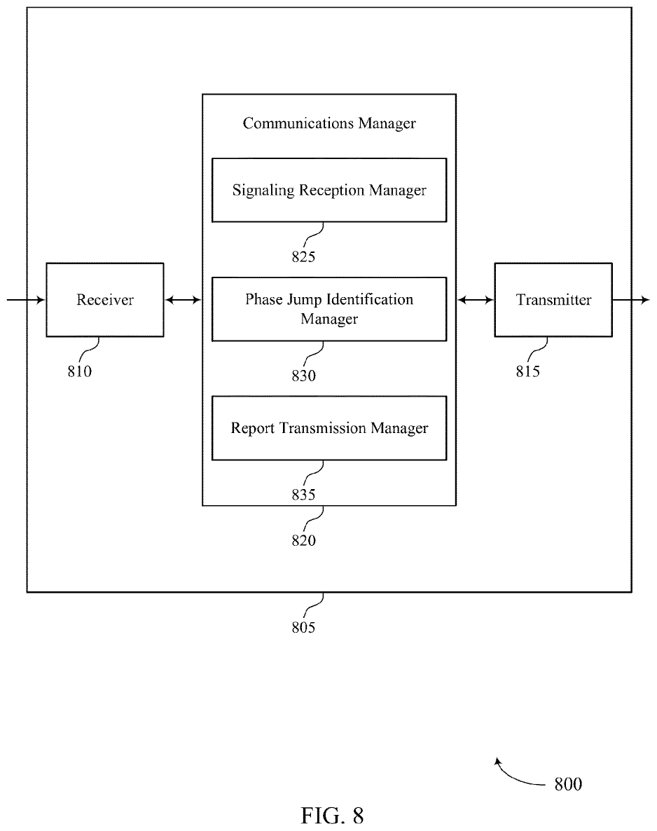

FIG. 8 shows a block diagram 800 of a device 805 that supports phase compensation for CJT in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to phase compensation for CJT). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to phase compensation for CJT). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of phase compensation for CJT as described herein. For example, the communications manager 820 may include a signaling reception manager 825, a phase jump identification manager 830, a report transmission manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication by a UE in accordance with examples as disclosed herein. The signaling reception manager 825 is capable of, configured to, or operable to support a means for receiving reference signaling from at least one reference TRP within a set of multiple slots, the at least one reference TRP included in a group of TRPs configured for joint transmissions to the UE. The phase jump identification manager 830 is capable of, configured to, or operable to support a means for identifying one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The report transmission manager 835 is capable of, configured to, or operable to support a means for transmitting, to a network entity, a report including information that is based on the one or more identified phase jumps. The signaling reception manager 825 is capable of, configured to, or operable to support a means for receiving a joint transmission from the group of TRPs based on the information included in the report.

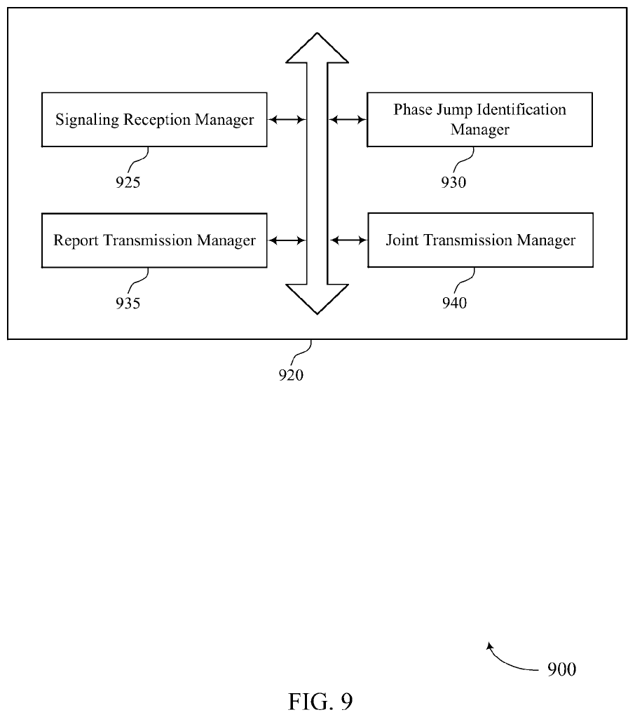

FIG. 9 shows a block diagram 900 of a communications manager 920 that supports phase compensation for CJT in accordance with one or more aspects of the present disclosure. The communications manager 920 may be an example of aspects of a communications manager 720, a communications manager 820, or both, as described herein. The communications manager 920, or various components thereof, may be an example of means for performing various aspects of phase compensation for CJT as described herein. For example, the communications manager 920 may include a signaling reception manager 925, a phase jump identification manager 930, a report transmission manager 935, a joint transmission manager 940, or any combination thereof. Each of these components, or components or subcomponents thereof (e.g., one or more processors, one or more memories), may communicate, directly or indirectly, with one another (e.g., via one or more buses).

The communications manager 920 may support wireless communication by a UE in accordance with examples as disclosed herein. The signaling reception manager 925 is capable of, configured to, or operable to support a means for receiving reference signaling from at least one reference TRP within a set of multiple slots, the at least one reference TRP included in a group of TRPs configured for joint transmissions to the UE. The phase jump identification manager 930 is capable of, configured to, or operable to support a means for identifying one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The report transmission manager 935 is capable of, configured to, or operable to support a means for transmitting, to a network entity, a report including information that is based on the one or more identified phase jumps. The signaling reception manager 925 is capable of, configured to, or operable to support a means for receiving a joint transmission from the group of TRPs based on the information included in the report.

The report transmission manager 935 is capable of, configured to, or operable to support a means for determining one or more channel state information metrics based on the one or more phase jumps, where the report includes a channel state information report, and where the information includes the one or more channel state information metrics that are based on the one or more phase jumps.

In some examples, the one or more channel state information metrics include a pre-coding matrix indicator value that is based on the one or more phase jumps, a channel quality indicator value that is based on the one or more phase jumps, a rank indicator value that is based on the one or more phase jumps, or any combination thereof.

In some examples, the report indicates the one or more phase jumps. In some examples, to indicate the one or more phase jumps, the report indicates a respective phase differential value, relative to a reference slot within the set of multiple slots, for each other slot within the set of multiple slots. In some examples, the respective phase differential value for a slot corresponds to a difference between a phase of the reference signaling as received by the UE within the slot and a phase of the reference signaling as received by the UE within the reference slot.

In some examples, the report transmission manager 935 is capable of, configured to, or operable to support a means for determining one or more channel state information metrics independent of the one or more phase jumps. In some examples, the report transmission manager 935 is capable of, configured to, or operable to support a means for indicating, via the report or a second report, the one or more channel state information metrics separately from the one or more phase jumps.

In some examples, to support receiving the reference signaling from the at least one reference TRP, the signaling reception manager 925 is capable of, configured to, or operable to support a means for receiving the reference signaling from a same set of one or more reference ports of the at least one reference TRP within each slot of the set of multiple slots.

In some examples, to support receiving the reference signaling from the at least one reference TRP, the signaling reception manager 925 is capable of, configured to, or operable to support a means for receiving reference signaling that indicates, to the UE, the at least one reference TRP and the set of one or more reference ports for receiving the reference signaling.

In some examples, the joint transmission manager 940 is capable of, configured to, or operable to support a means for identifying, by the UE, the at least one reference TRP from among the group of TRPs based on receiving the reference signaling from the at least one reference TRP prior to receiving other reference signaling from one or more other TRPs included in the group of TRPs. In some examples, the joint transmission manager 940 is capable of, configured to, or operable to support a means for identifying, by the UE, the one or more reference ports based on the one or more reference ports being associated with one or more port identities (IDs) that are lower than one or more other port IDs associated with one or more other ports of the at least one reference TRP.

In some examples, the signaling reception manager 925 is capable of, configured to, or operable to support a means for receiving other reference signaling from one or more other TRPs included in the group of TRPs, where the reference signaling received from the at least one reference TRP is frequency division multiplexed, time division duplexed, code division multiplexed, or any combination thereof relative to the other reference signaling.

In some examples, in a first subset of slots among the set of multiple slots, the reference signaling is received from the at least one reference TRP and the other reference signaling is also received from at least one of the one or more other TRPs. In some examples, in a second subset of slots among the set of multiple slots, the reference signaling is received from the at least one reference TRP and the other reference signaling is not received from any of the one or more other TRPs.

In some examples, the reference signaling received via first resources and the other reference signaling received via second resources included in a same reference signal resource set as the first resources.

In some examples, the reference signaling is received within a same frequency range within each slot of the set of multiple slots.

In some examples, the report transmission manager 935 is capable of, configured to, or operable to support a means for transmitting, to the network entity, a capability report that indicates an inability of the UE to maintain phase coherence when receiving signaling within multiple slots, where receiving the reference signaling from the at least one reference TRP within the set of multiple slots is based on the capability report indicating the inability of the UE to maintain phase coherence when receiving signaling within multiple slots.

In some examples, receiving the reference signaling from the at least one reference TRP within the set of multiple slots is based on a quantity of slots associated with channel state information reference signaling from the group of TRPs satisfying a threshold.

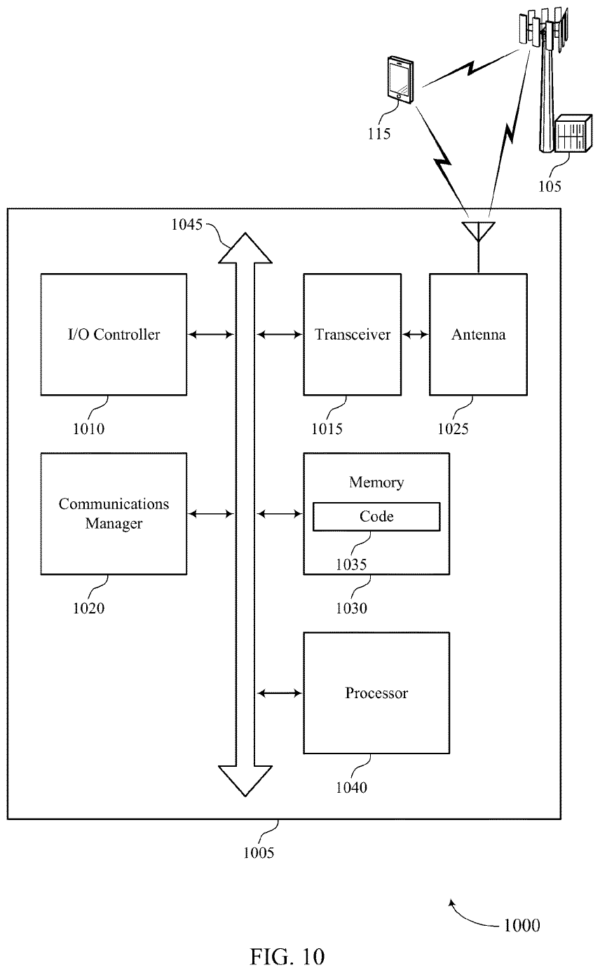

FIG. 10 shows a diagram of a system 1000 including a device 1005 that supports phase compensation for CJT in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting phase compensation for CJT). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communication by a UE in accordance with examples as disclosed herein. For example, the communications manager 1020 is capable of, configured to, or operable to support a means for receiving reference signaling from at least one reference TRP within a set of multiple slots, the at least one reference TRP included in a group of TRPs configured for joint transmissions to the UE. The communications manager 1020 is capable of, configured to, or operable to support a means for identifying one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The communications manager 1020 is capable of, configured to, or operable to support a means for transmitting, to a network entity, a report including information that is based on the one or more identified phase jumps. The communications manager 1020 is capable of, configured to, or operable to support a means for receiving a joint transmission from the group of TRPs based on the information included in the report.

By including or configuring the communications manager 1020 in accordance with examples as described herein, the device 1005 may support techniques for identifying phase jumps associated with reference signaling from one or more reference TRPs 105 of a group of TRPs 105 so that the phase jump information may be used to optimally configure the group of TRPs for subsequent joint transmission to the UE 115.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of phase compensation for CJT as described herein, or the at least one processor 1040 and the at least one memory 1030 may be otherwise configured to, individually or collectively, perform or support such operations.

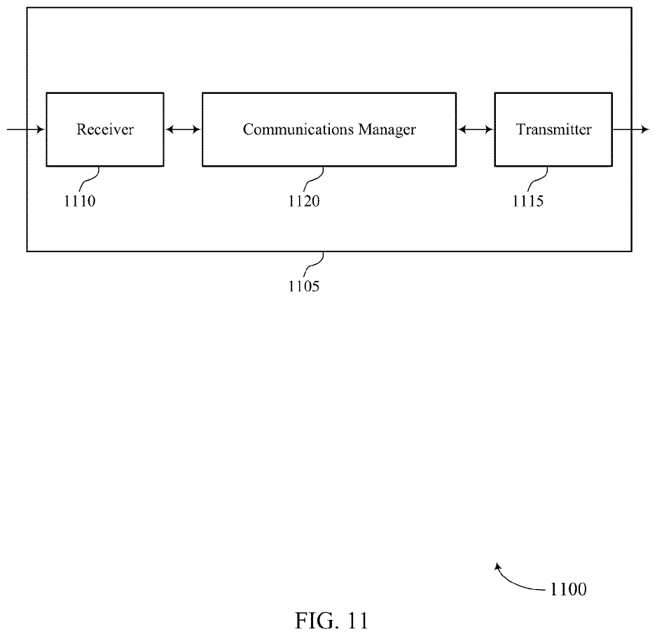

FIG. 11 shows a block diagram 1100 of a device 1105 that supports phase compensation for CJT in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of phase compensation for CJT as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication by a network entity in accordance with examples as disclosed herein. For example, the communications manager 1120 is capable of, configured to, or operable to support a means for transmitting, via at least one reference TRP, reference signaling to a UE within a set of multiple slots, the at least one reference TRP included in a group of TRPs configured for joint transmissions to the UE. The communications manager 1120 is capable of, configured to, or operable to support a means for receiving, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The communications manager 1120 is capable of, configured to, or operable to support a means for transmitting, via the group of TRPs, a joint transmission to the UE based on the information included in report.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for identifying phase jumps associated with reference signaling from one or more reference TRPs 105 of a group of TRPs 105 so that the phase jump information may be used to optimally configure the group of TRPs for subsequent joint transmission to the UE 115.

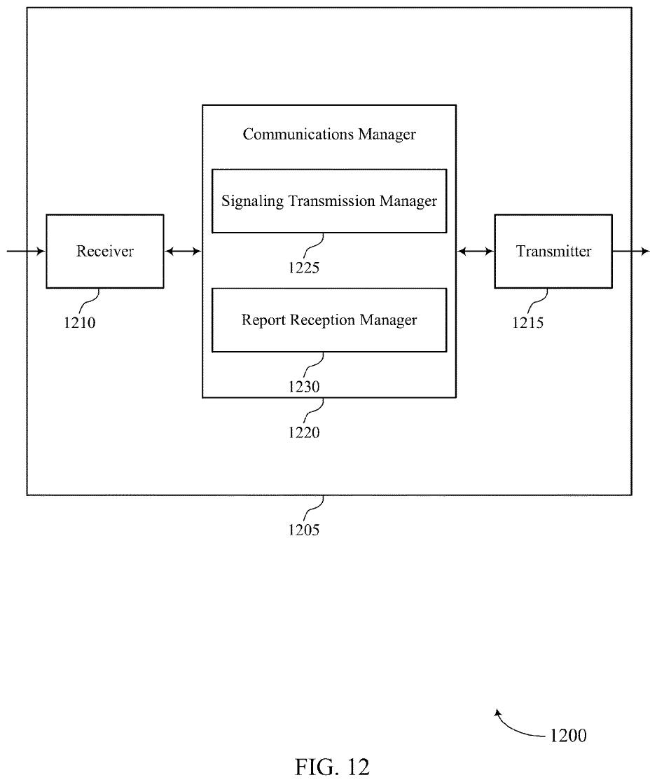

FIG. 12 shows a block diagram 1200 of a device 1205 that supports phase compensation for CJT in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of phase compensation for CJT as described herein. For example, the communications manager 1220 may include a signaling transmission manager 1225, a report reception manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication by a network entity in accordance with examples as disclosed herein. The signaling transmission manager 1225 is capable of, configured to, or operable to support a means for transmitting, via at least one reference TRP, reference signaling to a UE within a set of multiple slots, the at least one reference TRP included in a group of TRPs configured for joint transmissions to the UE. The report reception manager 1230 is capable of, configured to, or operable to support a means for receiving, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The signaling transmission manager 1225 is capable of, configured to, or operable to support a means for transmitting, via the group of TRPs, a joint transmission to the UE based on the information included in report.

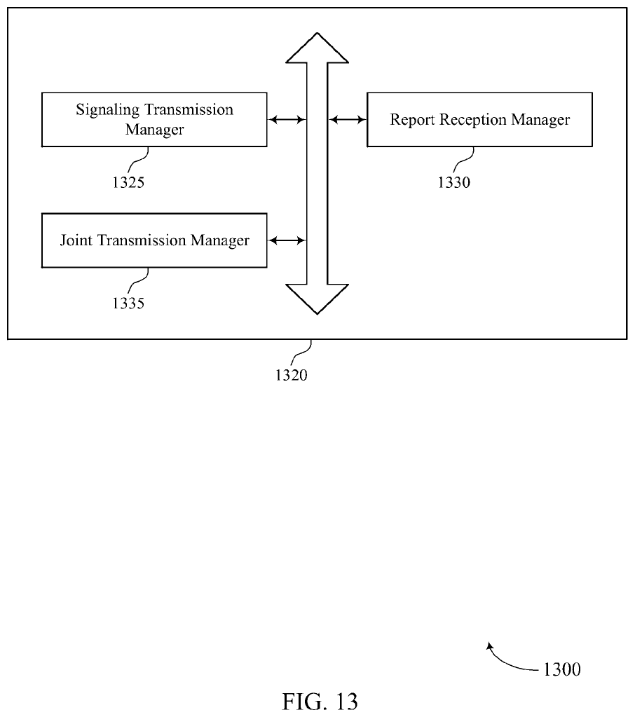

FIG. 13 shows a block diagram 1300 of a communications manager 1320 that supports phase compensation for CJT in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of phase compensation for CJT as described herein. For example, the communications manager 1320 may include a signaling transmission manager 1325, a report reception manager 1330, a joint transmission manager 1335, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication by a network entity in accordance with examples as disclosed herein. The signaling transmission manager 1325 is capable of, configured to, or operable to support a means for transmitting, via at least one reference TRP, reference signaling to a UE within a set of multiple slots, the at least one reference TRP included in a group of TRPs configured for joint transmissions to the UE. The report reception manager 1330 is capable of, configured to, or operable to support a means for receiving, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The joint transmission manager 1335 is capable of, configured to, or operable to support a means for transmitting, via the group of TRPs, a joint transmission to the UE based on the information included in report.

In some examples, the report comprises a channel state information report, and the information comprises one or more channel state information metrics that are based at least in part on the one or more phase jumps. In some examples, to support transmitting the joint transmission via the group of TRPs, the joint transmission manager 1335 is capable of, configured to, or operable to support a means for transmitting the joint transmission using a common phase configuration for each TRP of the group of TRPs.

In some examples, the one or more channel state information metrics include a pre-coding matrix indicator value that is based on the one or more phase jumps, a channel quality indicator value that is based on the one or more phase jumps, a rank indicator value that is based on the one or more phase jumps, or any combination thereof.

In some examples, the report indicates the one or more phase jumps. In some examples, to indicate the one or more phase jumps, the report indicates a respective phase differential value, relative to a reference slot within the set of multiple slots, for each other slot within the set of multiple slots. In some examples, the respective phase differential value for a slot corresponds to a difference between a phase of the reference signaling as received by the UE within the slot and a phase of the reference signaling as received by the UE within the reference slot.

In some examples, to support transmitting the joint transmission via the group of TRPs, the joint transmission manager 1335 is capable of, configured to, or operable to support a means for transmitting the joint transmission using respective phase configurations for the TRPs in the group of TRPs, where the respective phase configurations are different for at least two TRPs in the group of TRPs and are based on the one or more indicated phase jumps.

In some examples, to support transmitting the joint transmission via the group of TRPs, the report reception manager 1330 is capable of, configured to, or operable to support a means for receiving, via the report or a second report from the UE, second information that one or more channel state information metrics separately from the one or more phase jumps, where one or more channel state information metrics are independent of the one or more phase jumps.

In some examples, to support transmitting the reference signaling via the at least one reference TRPs, the signaling transmission manager 1325 is capable of, configured to, or operable to support a means for transmitting the reference signaling via the same set of one or more reference ports of the at least one reference TRP within each slot of the set of multiple slots.

In some examples, to support transmitting the reference signaling via the at least one reference TRPs, the signaling transmission manager 1325 is capable of, configured to, or operable to support a means for transmitting signaling that indicates, to the UE, at least one reference TRP and a set of one or more reference ports.

In some examples, the at least one reference TRP transmits the reference signaling before one or more other TRPs included in the group of TRPs transmit other reference signaling to the UE. In some examples, the one or more reference ports are associated with one or more port identities (IDs) that are lower than one or more other port IDs associated with one or more other ports of the at least one reference TRP.

In some examples, the signaling transmission manager 1325 is capable of, configured to, or operable to support a means for transmitting other reference signaling via one or more other TRPs included in the group of TRPs, where the reference signaling transmitted via the at least one reference TRP is frequency division multiplexed, time division duplexed, code division multiplexed, or any combination thereof relative to the other reference signaling.

In some examples, the signaling transmission manager 1325 is capable of, configured to, or operable to support a means for transmitting the reference signaling via first resources and transmitting the other reference signaling via second resources included in a same reference signal resource set as the first resources.

In some examples, in a first subset of slots among the set of multiple slots, the reference signaling is transmitted via the at least one reference TRP and the other reference signaling is also transmitted via at least one of the one or more other TRPs. In some examples, in a second subset of slots among the set of multiple slots, the reference signaling is transmitted via the at least one reference TRP and the other reference signaling is not transmitted via any of the one or more other TRPs.

In some examples, the reference signaling is transmitted within a same frequency range within each slot of the set of multiple slots.

In some examples, the report reception manager 1330 is capable of, configured to, or operable to support a means for receiving, from the UE, a capability report that indicates an inability of the UE to maintain phase coherence when receiving signaling within multiple slots, where transmitting the reference signaling via the at least one reference TRP within the set of multiple slots is based on the capability report indicating the inability of the UE to maintain phase coherence when receiving signaling within multiple slots.

In some examples, transmitting reference signaling from the at least one reference TRP within the set of multiple slots is based on a quantity of slots associated with channel state information reference signaling from the group of TRPs satisfying a threshold.

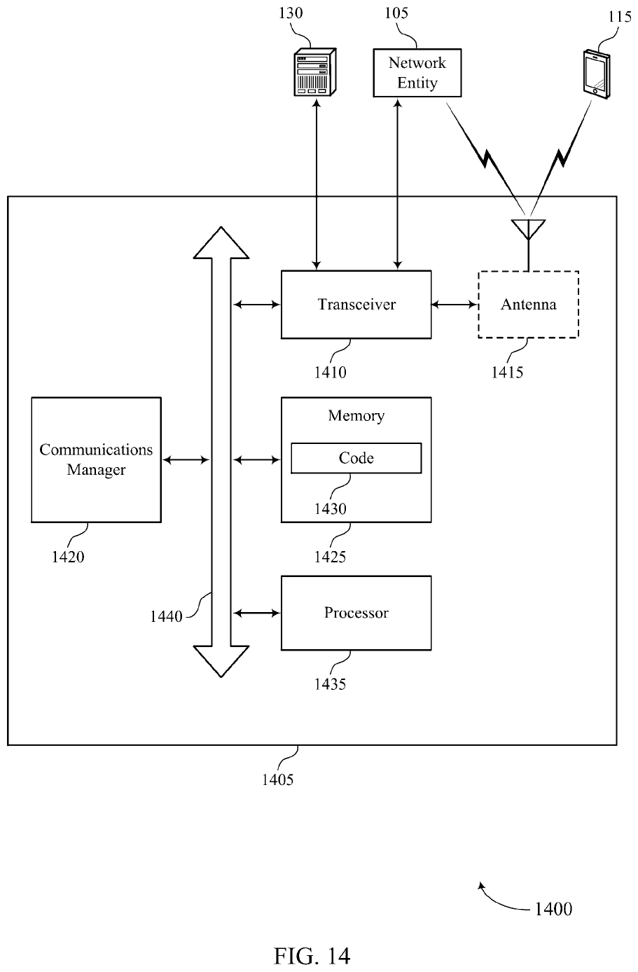

FIG. 14 shows a diagram of a system 1400 including a device 1405 that supports phase compensation for CJT in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting phase compensation for CJT). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405.

The processing system of the device 1405 may interface with other components of the device 1405 and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105 and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication by a network entity in accordance with examples as disclosed herein. For example, the communications manager 1420 is capable of, configured to, or operable to support a means for transmitting, via at least one reference TRP, reference signaling to a UE within a set of multiple slots, the at least one reference TRP included in a group of TRPs configured for joint transmissions to the UE. The communications manager 1420 is capable of, configured to, or operable to support a means for receiving, from the UE, a report including information that is based on one or more phase jumps associated with the reference signaling, where a phase jump of the one or more phase jumps includes a difference between a phase of the reference signaling as received by the UE during a first slot of the set of multiple slots and a phase of the reference signaling as received by the UE during a subsequent slot of the set of multiple slots. The communications manager 1420 is capable of, configured to, or operable to support a means for transmitting, via the group of TRPs, a joint transmission to the UE based on the information included in report.

By including or configuring the communications manager 1420 in accordance with examples as described herein, the device 1405 may support techniques for identifying phase jumps associated with reference signaling from one or more reference TRPs 105 of a group of TRPs 105 so that the phase jump information may be used to optimally configure the group of TRPs for subsequent joint transmission to the UE 115.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. For example, the communications manager 1420 may be configured to receive or transmit messages or other signaling as described herein via the transceiver 1410. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of phase compensation for CJT as described herein, or the at least one processor 1435 and the at least one memory 1425 may be otherwise configured to, individually or collectively, perform or support such operations.

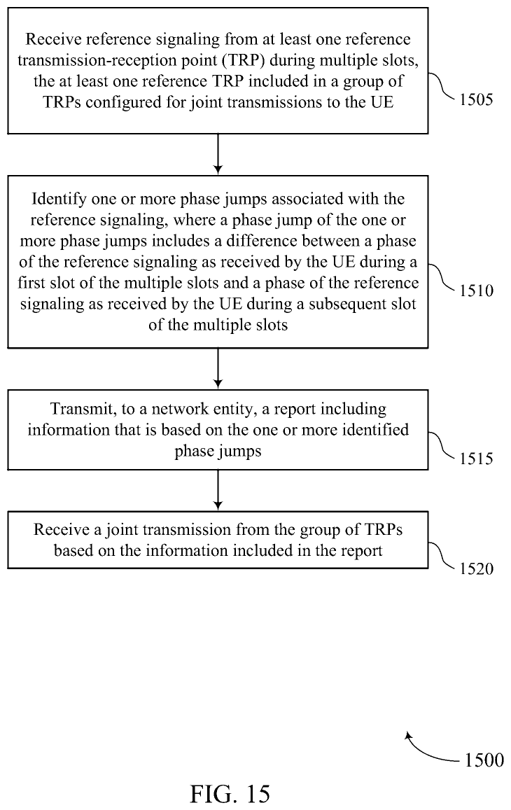

FIG. 15 shows a flowchart illustrating a method 1500 that supports phase compensation for CJT in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving reference signaling from at least one reference TRP during multiple slots, the at least one reference TRP included in a group of TRPs configured for joint transmissions to the UE. The operations of block 1505 may be performed in accordance with examples as disclosed herein. In some examples, aspects of the operations of 1505 may be performed by a signaling reception manager 925 as described with reference to FIG. 9. Additionally, or alternatively, means for performing 1505 may, but not necessarily, include, for example, antenna 1025, transceiver 1015, communications manager 1020, memory 1030 (including code 1035), processor 1040 and/or bus 1045.

At 1510, the method may include identifying one or more phase jumps associated with the reference signaling, where a phase jump of the one or more phase jumps includes a difference between a phase of the reference signaling as received by the UE during a first slot of the multiple slots and a phase of the reference signaling as received by the UE during a subsequent slot of the multiple slots. The operations of block 1510 may be performed in accordance with examples as disclosed herein. In some examples, aspects of the operations of 1510 may be performed by a phase jump identification manager 930 as described with reference to FIG. 9. Additionally, or alternatively, means for performing 1510 may, but not necessarily, include, for example, antenna 1025, transceiver 1015, communications manager 1020, memory 1030 (including code 1035), processor 1040 and/or bus 1045.

At 1515, the method may include transmitting, to a network entity, a report including information that is based on the one or more identified phase jumps. The operations of block 1515 may be performed in accordance with examples as disclosed herein. In some examples, aspects of the operations of 1515 may be performed by a report transmission manager 935 as described with reference to FIG. 9. Additionally, or alternatively, means for performing 1515 may, but not necessarily, include, for example, antenna 1025, transceiver 1015, communications manager 1020, memory 1030 (including code 1035), processor 1040 and/or bus 1045.

At 1520, the method may include receiving a joint transmission from the group of TRPs based on the information included in the report. The operations of block 1520 may be performed in accordance with examples as disclosed herein. In some examples, aspects of the operations of 1520 may be performed by a joint transmission manager 940 as described with reference to FIG. 9. Additionally, or alternatively, means for performing 1520 may, but not necessarily, include, for example, antenna 1025, transceiver 1015, communications manager 1020, memory 1030 (including code 1035), processor 1040 and/or bus 1045.

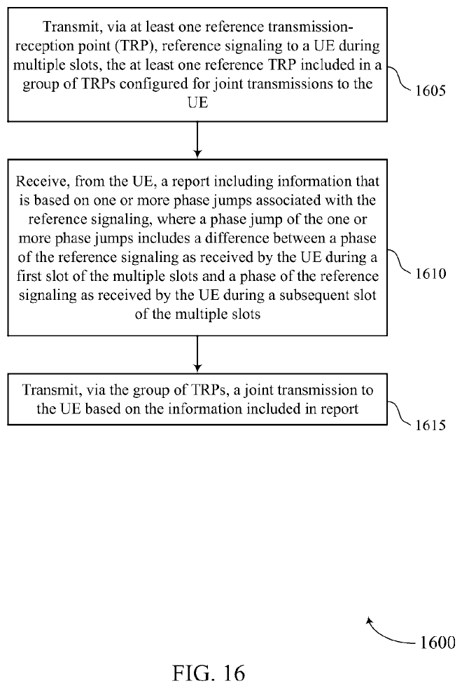

FIG. 16 shows a flowchart illustrating a method 1600 that supports phase compensation for CJT in accordance with aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, via at least one reference TRP, reference signaling to a UE during multiple slots, the at least one reference TRP included in a group of TRPs configured for joint transmissions to the UE. The operations of block 1605 may be performed in accordance with examples as disclosed herein. In some examples, aspects of the operations of 1605 may be performed by a signaling transmission manager 1325 as described with reference to FIG. 13. Additionally, or alternatively, means for performing 1605 may, but not necessarily, include, for example, antenna 1415, transceiver 1410, communications manager 1420, memory 1425 (including code 1430), processor 1435 and/or bus 1440.

At 1610, the method may include receiving, from the UE, a report including information that is based on one or more phase jumps associated with the reference signaling, where a phase jump of the one or more phase jumps includes a difference between a phase of the reference signaling as received by the UE during a first slot of the multiple slots and a phase of the reference signaling as received by the UE during a subsequent slot of the multiple slots. The operations of block 1610 may be performed in accordance with examples as disclosed herein. In some examples, aspects of the operations of 1610 may be performed by a report reception manager 1330 as described with reference to FIG. 13. Additionally, or alternatively, means for performing 1610 may, but not necessarily, include, for example, antenna 1415, transceiver 1410, communications manager 1420, memory 1425 (including code 1430), processor 1435 and/or bus 1440.

At 1615, the method may include transmitting, via the group of TRPs, a joint transmission to the UE based on the information included in report. The operations of block 1615 may be performed in accordance with examples as disclosed herein. In some examples, aspects of the operations of 1615 may be performed by a joint transmission manager 1335 as described with reference to FIG. 13. Additionally, or alternatively, means for performing 1615 may, but not necessarily, include, for example, antenna 1415, transceiver 1410, communications manager 1420, memory 1425 (including code 1430), processor 1435 and/or bus 1440.

The following provides an overview of aspects of the present disclosure:
Aspect 1: A method for wireless communication by a UE, comprising: receiving reference signaling from at least one TRP during a plurality of slots, the at least one reference TRP included in a group of TRPs configured for joint transmissions to the UE; identifying one or more phase jumps associated with the reference signaling, wherein a phase jump of the one or more phase jumps comprises a difference between a phase of the reference signaling as received by the UE during a first slot of the plurality of slots and a phase of the reference signaling as received by the UE during a subsequent slot of the plurality of slots; transmitting, to a network entity, a report comprising information that is based at least in part on the one or more identified phase jumps; and receiving a joint transmission from the group of TRPs based at least in part on the information included in the report.
Aspect 2: The method of aspect 1, further comprising: determining one or more channel state information metrics based at least in part on the one or more phase jumps, wherein the report comprises a channel state information report, and wherein the information comprises the one or more channel state information metrics that are based at least in part on the one or more phase jumps.
Aspect 3: The method of aspect 2, wherein the one or more channel state information metrics comprise a pre-coding matrix indicator value that is based at least in part on the one or more phase jumps, a channel quality indicator value that is based at least in part on the one or more phase jumps, a rank indicator value that is based at least in part on the one or more phase jumps, or any combination thereof.
Aspect 4: The method of any of aspects 1 through 3, wherein the report indicates the one or more phase jumps.
Aspect 5: The method of aspect 4, wherein to indicate the one or more phase jumps, the report indicates a respective phase differential value, relative to a reference slot among the plurality of slots, for each other slot among the plurality of slots, and the respective phase differential value for a slot corresponds to a difference between a phase of the reference signaling as received by the UE within the slot and a phase of the reference signaling as received by the UE within the reference slot.
Aspect 6: The method of any of aspects 4 through 5, further comprising: determining one or more channel state information metrics independent of the one or more phase jumps; and indicating, via the report or a second report, the one or more channel state information metrics separately from the one or more phase jumps.
Aspect 7: The method of any of aspects 1 through 6, wherein receiving the reference signaling from the at least one reference TRP comprises: receiving the reference signaling from a same set of one or more reference ports of the at least one reference TRP within each slot of the plurality of slots.
Aspect 8: The method of aspect 7, further comprising: receiving signaling that indicates, to the UE, the at least one reference TRP and the set of one or more reference ports for receiving the reference signaling.
Aspect 9: The method of any of aspects 7 through 8, further comprising: identifying, by the UE, the at least one reference TRP from among the group of TRPs based at least in part on receiving the reference signaling from the at least one reference TRP prior to receiving other reference signaling from one or more other TRPs included in the group of TRPs; and identifying, by the UE, the one or more reference ports based at least in part on the one or more reference ports being associated with one or more port IDs that are lower than one or more other port IDs associated with one or more other ports of the at least one reference TRP.
Aspect 10: The method of any of aspects 1 through 9, further comprising: receiving other reference signaling from one or more other TRPs included in the group of TRPs, wherein the reference signaling received from the at least one reference TRP is frequency division multiplexed, time division duplexed, code division multiplexed, or any combination thereof relative to the other reference signaling.
Aspect 11: The method of aspect 10, wherein in a first subset of slots among the plurality of slots, the reference signaling is received from the at least one reference TRP and the other reference signaling is also received from at least one of the one or more other TRPs; and in a second subset of slots among the plurality of slots, the reference signaling is received from the at least one reference TRP and the other reference signaling is not received from any of the one or more other TRPs.
Aspect 12: The method of any of aspects 10 through 11, wherein the reference signaling is received via first resources; and the other reference signaling is received via second resources included in a same reference signal resource set as the first resources.
Aspect 13: The method of any of aspects 1 through 12, wherein the reference signaling is received within a same frequency range within each slot of the plurality of slots.
Aspect 14: The method of any of aspects 1 through 13, further comprising: transmitting, to the network entity, a capability report that indicates an inability of the UE to maintain phase coherence when receiving signaling within multiple slots, wherein receiving the reference signaling from the at least one reference TRP among the plurality of slots is based at least in part on the capability report indicating the inability of the UE to maintain phase coherence when receiving signaling within multiple slots.
Aspect 15: The method of any of aspects 1 through 14, wherein receiving the reference signaling from the at least one reference TRP among the plurality of slots is based at least in part on a quantity of slots associated with channel state information reference signaling from the group of TRPs satisfying a threshold.
Aspect 16: A method for wireless communication by a network entity, comprising: transmitting, via at least one reference TRP, reference signaling to a UE during a plurality of slots, the at least one reference TRP included in a group of TRPs configured for joint transmissions to the UE; receiving, from the UE, a report comprising information that is based at least in part on one or more phase jumps associated with the reference signaling, wherein a phase jump of the one or more phase jumps comprises a difference between a phase of the reference signaling as received by the UE during a first slot of the plurality of slots and a phase of the reference signaling as received by the UE during a subsequent slot of the plurality of slots; and transmitting, via the group of TRPs, a joint transmission to the UE based at least in part on the information included in report.
Aspect 17: The method of aspect 16, wherein the report comprises a channel state information report and the information comprises one or more channel state information metrics that are based at least in part on the one or more phase jumps, and wherein transmitting the joint transmission via the group of TRPs comprises: transmitting the joint transmission using a common phase configuration for each TRP of the group of TRPs.
Aspect 18: The method of aspect 17, wherein the one or more channel state information metrics comprise a pre-coding matrix indicator value that is based at least in part on the one or more phase jumps, a channel quality indicator value that is based at least in part on the one or more phase jumps, a rank indicator value that is based at least in part on the one or more phase jumps, or any combination thereof.
Aspect 19: The method of any of aspects 16 through 18, wherein the report indicates the one or more phase jumps, and wherein transmitting the joint transmission via the group of TRPs comprises: transmitting the joint transmission using respective phase configurations for the TRPs in the group of TRPs, wherein the respective phase configurations are different for at least two TRPs in the group of TRPs and are based at least in part on the one or more indicated phase jumps.
Aspect 20: The method of aspect 19, wherein to indicate the one or more phase jumps, the report indicates a respective phase differential value for each other slot among the plurality of slots relative to a reference slot among the plurality of slots, and the respective phase differential value for a slot corresponds to a difference between a phase of the reference signaling as received by the UE within the slot and a phase of the reference signaling as received by the UE within the reference slot.
Aspect 21: The method of any of aspects 19 through 20, further comprising: receiving, via the report or a second report from the UE, second information that one or more channel state information metrics separately from the one or more phase jumps, wherein one or more channel state information metrics are independent of the one or more phase jumps.
Aspect 22: The method of any of aspects 16 through 21, wherein transmitting the reference signaling via the at least one reference TRPs comprises: transmitting the reference signaling via a same set of one or more reference ports of the at least one reference TRP within each slot of the plurality of slots.
Aspect 23: The method of aspect 22, further comprising: transmitting signaling that indicates, to the UE, the at least one reference TRP and the set of one or more reference ports.
Aspect 24: The method of any of aspects 22 through 23, wherein the at least one reference TRP transmits the reference signaling before one or more other TRPs included in the group of TRPs transmit other reference signaling to the UE; and the one or more reference ports are associated with one or more port IDs that are lower than one or more other port IDs associated with one or more other ports of the at least one reference TRP.
Aspect 25: The method of any of aspects 16 through 24, further comprising: transmitting other reference signaling via one or more other TRPs included in the group of TRPs, wherein the reference signaling transmitted via the at least one reference TRP is frequency division multiplexed, time division duplexed, code division multiplexed, or any combination thereof relative to the other reference signaling.
Aspect 26: The method of aspect 25, wherein in a first subset of slots among the plurality of slots, the reference signaling is transmitted via the at least one reference TRP and the other reference signaling is also transmitted via at least one of the one or more other TRPs; and in a second subset of slots among the plurality of slots, the reference signaling is transmitted via the at least one reference TRP and the other reference signaling is not transmitted via any of the one or more other TRPs.
Aspect 27: The method of any of aspects 25 through 26, wherein the reference signaling is transmitted via first resources; and the other reference signaling is transmitted via second resources included in a same reference signal resource set as the first resources.
Aspect 28: The method of any of aspects 16 through 27, wherein the reference signaling is transmitted within a same frequency range within each slot of the plurality of slots.
Aspect 29: The method of any of aspects 16 through 28, further comprising: receiving, from the UE, a capability report that indicates an inability of the UE to maintain phase coherence when receiving signaling within multiple slots, wherein transmitting the reference signaling via the at least one reference TRP among the plurality of slots is based at least in part on the capability report indicating the inability of the UE to maintain phase coherence when receiving signaling within multiple slots.
Aspect 30: The method of any of aspects 16 through 29, wherein transmitting reference signaling from the at least one reference TRP among the plurality of slots is based at least in part on a quantity of slots associated with channel state information reference signaling from the group of TRPs satisfying a threshold.
Aspect 31: An apparatus (e.g., UE) for wireless communication, comprising one or more memories storing processor-executable code, a transceiver, and one or more processors coupled with the transceiver and with the one or more memories and individually or collectively operable to execute the code to perform a method of any of aspects 1 through 15.
Aspect 32: A UE for wireless communication, comprising at least one means for performing a method of any of aspects 1 through 15.
Aspect 33: A non-transitory computer-readable medium storing code for wireless communication, the code comprising instructions executable by a processor to perform a method of any of aspects 1 through 15.
Aspect 34: A network entity for wireless communication, comprising one or more memories storing processor-executable code, and one or more processors coupled with the one or more memories and individually or collectively operable to execute the code to perform a method of any of aspects 16 through 30.
Aspect 35: A network entity for wireless communication, comprising at least one means for performing a method of any of aspects 16 through 30.
Aspect 36: A non-transitory computer-readable medium storing code for wireless communication, the code comprising instructions executable by a processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
memory;
a transceiver; and
at least one processor of a user equipment (UE), the at least one processor coupled with the memory and configured to:
receive, via the transceiver, reference signaling from at least one reference transmission-reception point (TRP) during a plurality of slots, the at least one reference TRP included in a group of TRPs configured for joint transmissions to the UE;
identify one or more phase jumps associated with the reference signaling, wherein a phase jump of the one or more phase jumps comprises a difference between a phase of the reference signaling as received by the UE during a first slot of the plurality of slots and a phase of the reference signaling as received by the UE during a subsequent slot of the plurality of slots;
transmit, via the transceiver to a network entity, a report comprising information that is based at least in part on the one or more identified phase jumps; and
receive, via the transceiver, a joint transmission from the group of TRPs based at least in part on the information included in the report.

2. The apparatus of claim 1, the at least one processor further configured to:
determine one or more channel state information metrics based at least in part on the one or more phase jumps, wherein the report comprises a channel state information report, and wherein the information comprises the one or more channel state information metrics that are based at least in part on the one or more phase jumps; or
determine the one or more channel state information metrics independent of the one or more phase jumps, and
indicate, via the report or a second report, the one or more channel state information metrics determined independently of the one or more phase jumps separately from the one or more phase jumps.

3. The apparatus of claim 2, wherein the one or more channel state information metrics comprise a pre-coding matrix indicator value that is based at least in part on the one or more phase jumps, a channel quality indicator value that is based at least in part on the one or more phase jumps, a rank indicator value that is based at least in part on the one or more phase jumps, or any combination thereof.

4. (canceled)

5. The apparatus of claim 1, wherein the information that is based at least in part on the one or more identified phase jumps comprises an indication of the one or more phase jumps, the indication indicating:
a respective phase differential value, relative to a reference slot among the plurality of slots, for each other slot among the plurality of slots, the respective phase differential value for a given slot corresponds to a difference between a phase of the reference signaling as received by the UE within the slot and a phase of the reference signaling as received by the UE within the reference slot.

6. (canceled)

7. The apparatus of claim 1, wherein, to receive the reference signaling from the at least one reference TRP, the at least one processor is configured to:
receive, via the transceiver, the reference signaling from a same set of one or more reference ports of the at least one reference TRP within each slot of the plurality of slots, the at least one processor further configured to:
identify the at least one reference TRP from among the group of TRPs based at least in part on receiving the reference signaling from the at least one reference TRP prior to receiving other reference signaling from one or more other TRPs included in the group of TRPs; and
identify the one or more reference ports based at least in part on the one or more reference ports being associated with one or more port identities (IDs) that are lower than one or more other port IDs associated with one or more other ports of the at least one reference TRP.

8. (canceled)

9. (canceled)

10. The apparatus of claim 1, the at least one processor further configured to:
receive, via the transceiver, other reference signaling from one or more other TRPs included in the group of TRPs, wherein the reference signaling received from the at least one reference TRP is frequency division multiplexed, time division multiplexed, code division multiplexed, or any combination thereof relative to the other reference signaling, wherein to receive the reference signaling from the at least one reference TRP, the at least one processor is configured to:
in a first subset of slots among the plurality of slots, receive the reference signaling from the at least one reference TRP and the other reference signaling from at least one of the one or more other TRPs; and
in a second subset of slots among the plurality of slots, receive the reference signaling from the at least one reference TRP and not receive the other reference signaling from any of the one or more other TRPs.

11. (canceled)

12. The apparatus of claim 1, the at least one processor further configured to:
transmit, via the transceiver to the network entity, a capability report indicating an inability of the UE to maintain phase coherence when receiving reference signaling during multiple slots, wherein the at least one processor is configured to receive the reference signaling from the at least one reference TRP during the plurality of slots based at least in part on the capability report indicating the inability of the UE to maintain phase coherence when receiving reference signaling during multiple slots.

13. (canceled)

14. An apparatus for wireless communication, comprising:
memory; and
at least one processor of a network entity, the at least one processor coupled with the memory and configured to:
transmit, via at least one reference transmission-reception point (TRP), reference signaling to a user equipment (UE) during a plurality of slots, the at least one reference TRP included in a group of TRPs configured for joint transmissions to the UE;
receive, from the UE, a report comprising information that is based at least in part on one or more phase jumps associated with the reference signaling, wherein a phase jump of the one or more phase jumps comprises a difference between a phase of the reference signaling as received by the UE during a first slot of the plurality of slots and a phase of the reference signaling as received by the UE during a subsequent slot of the plurality of slots; and
transmit, via the group of TRPs, a joint transmission to the UE based at least in part on the information included in report.

15. The apparatus of claim 14, wherein the report comprises a channel state information report and the information comprises one or more channel state information metrics that are based at least in part on the one or more phase jumps, and wherein, to transmit joint transmission via the group of TRPs, the at least one processor is further configured to:
transmit the joint transmission using a common phase configuration for each TRP of the group of TRPs.

16. The apparatus of claim 14, wherein the report indicates the one or more phase jumps, and wherein, to transmit joint transmission via the group of TRPs, the at least one processor is further configured to:
transmit the joint transmission using respective phase configurations for the TRPs in the group of TRPs, wherein the respective phase configurations are different for at least two TRPs in the group of TRPs and are based at least in part on the one or more phase jumps.

17. The apparatus of claim 14, wherein, to transmit the reference signaling via the at least one reference TRPs, the at least one processor is further configured to:
transmit the reference signaling via a same set of one or more reference ports of the at least one reference TRP within each slot of the plurality of slots.

18. The apparatus of claim 14, the at least one processor further configured to:
transmit other reference signaling via one or more other TRPs included in the group of TRPs, wherein the reference signaling transmitted via the at least one reference TRP is frequency division multiplexed, time division multiplexed, code division multiplexed, or any combination thereof relative to the other reference signaling.

19. The apparatus of claim 18, wherein the at least one processor is configured to:
in a first subset of slots among the plurality of slots, transmit the reference signaling via the at least one reference TRP and the other reference signaling via at least one of the one or more other TRPs; and
in a second subset of slots among the plurality of slots, transmit the reference signaling via the at least one reference TRP and not transmit the other reference signaling via any of the one or more other TRPs.

20. The apparatus of claim 18, wherein the at least one processor is configured to:
transmit the reference signaling via first resources; and
transmit the other reference signaling via second resources that are included in a same reference signal resource set as the first resources.

21. (canceled)

22. The apparatus of claim 14, the at least one processor further configured to:
receive, from the UE, a capability report indicating an inability of the UE to maintain phase coherence when receiving reference signaling during multiple slots, wherein the at least one processor is configured to transmit the reference signaling via the at least one reference TRP among the plurality of slots based at least in part on the capability report indicating the inability of the UE to maintain phase coherence when receiving reference signaling during multiple slots.

23. The apparatus of claim 14, wherein the at least one processor is configured to:
transmit the reference signaling from the at least one reference TRP among the plurality of slots based at least in part on a quantity of slots associated with channel state information reference signaling from the group of TRPs satisfying a threshold.

24. A method for wireless communication by a user equipment (UE), comprising:
receiving reference signaling from at least one reference transmission-reception point (TRP) during a plurality of slots, the at least one reference TRP included in a group of TRPs configured for joint transmissions to the UE;
identifying one or more phase jumps associated with the reference signaling, wherein a phase jump of the one or more phase jumps comprises a difference between a phase of the reference signaling as received by the UE during a first slot of the plurality of slots and a phase of the reference signaling as received by the UE during a subsequent slot of the plurality of slots;
transmitting, to a network entity, a report comprising information that is based at least in part on the one or more identified phase jumps; and
receiving a joint transmission from the group of TRPs based at least in part on the information included in the report.

25. The method of claim 24, further comprising:
determining one or more channel state information metrics based at least in part on the one or more phase jumps, wherein the report comprises a channel state information report, and wherein the information comprises the one or more channel state information metrics that are based at least in part on the one or more phase jumps.

26. The method of claim 24, wherein:
the report indicates the one or more phase jumps, and
to indicate the one or more phase jumps, the report indicates a respective phase differential value, relative to a reference slot among the plurality of slots, for each other slot among the plurality of slots, the respective phase differential value for a slot corresponding to a difference between a phase of the reference signaling as received by the UE within the slot and a phase of the reference signaling as received by the UE within the reference slot.

27. The method of claim 24, wherein the report indicates the one or more phase jumps, the method further comprising:
determining one or more channel state information metrics independent of the one or more phase jumps; and
indicating, via the report or a second report, the one or more channel state information metrics separately from the one or more phase jumps.

28. (canceled)

29. (canceled)

30. (canceled)
